(19) United States
(12) Patent Application Publication
(10) Pub. No.: US 2017/0083343 A1
(43) Pub. Date: Mar. 23, 2017

(54) OUT OF ORDER COMMIT

(71) Applicant: Microsoft Technology Licensing, LLC, Redmond, WA (US)

(72) Inventor: Douglas C. Burger, Bellevue, WA (US)

(73) Assignee: Microsoft Technology Licensing, LLC, Redmond, WA (US)

(21) Appl. No.: 14/942,461

(22) Filed: Nov. 16, 2015

Related U.S. Application Data
(60) Provisional application No. 62/221,003, filed on Sep. 19, 2015.

(51) Int. Cl. G06F 9/38

(52) U.S. Cl. CPC G06F 9/3855

(57) ABSTRACT

The disclosed technology can be used for executing and committing instruction blocks of a block-based processor architecture out-of-order. In one example of the disclosed technology, an apparatus can include a plurality of block-based processor cores which can include a first group of cores and a second group of cores. The first group of cores can be configured to commit instruction blocks of the set of instruction blocks in a sequential program order. The second group of cores can be configured to commit instruction blocks of the set of instruction blocks out-of-order relative to the sequential program order.

### CROSS-REFERENCE TO RELATED APPLICATIONS

This application claims the benefit of U.S. Provisional Application No. 62/221,003, entitled “BLOCK-BASED PROCESSORS,” filed Sep. 19, 2015, the entire disclosure of which is incorporated herein by reference in its entirety.

### BACKGROUND

Microprocessors have benefitted from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Methods, apparatus, and computer-readable storage devices are disclosed for executing and committing instruction blocks out-of-order in block-based processor instruction set architecture (BB-ISA). The described techniques and tools can potentially improve processor performance and can be implemented separately, or in various combinations with each other. As will be described more fully below, the described techniques and tools can be implemented in a digital signal processor, microprocessor, application-specific integrated circuit (ASIC), a soft processor (e.g., a microprocessor core implemented in a field programmable gate array (FPGA) using reconfigurable logic), programmable logic, or other suitable logic circuitry. As will be readily apparent to one of ordinary skill in the art, the disclosed technology can be implemented in various computing platforms, including, but not limited to, servers, mainframes, cellphones, smartphones, PDAs, handheld devices, handheld computers, touch screen tablet devices, tablet computers, wearable computers, and laptop computers.

In some examples of the disclosed technology, instruction blocks of a block-based processor architecture can be executed and committed out-of-order. For example, an apparatus can include a plurality of block-based processor cores which can include a first group of cores and a second group of cores. The first group of cores can be configured to commit instruction blocks of the set of instruction blocks in a sequential program order. The second group of cores can be configured to commit instruction blocks of the set of instruction blocks out-of-order relative to the sequential program order.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor including multiple processor cores, as can be used in some examples of the disclosed technology.

FIG. 2 illustrates a block-based processor core, as can be used in some examples of the disclosed technology.

FIG. 3 illustrates a number of instruction blocks, according to certain examples of disclosed technology.

FIG. 4 illustrates portions of source code and respective instruction blocks.

FIG. 5 illustrates block-based processor headers and instructions, as can be used in some examples of the disclosed technology.

FIG. 6 is a flowchart illustrating an example of a progression of states of a processor core of a block-based processor.

FIG. 7 is a flowchart illustrating an example compiler method, as can be used in some examples of the disclosed technology.

FIG. 8 is a diagram illustrating an example of committing instruction blocks in-order.

FIG. 9 is a diagram illustrating an example of committing instruction blocks out-of-order.

FIG. 10 is a diagram illustrating a block-based processor and memory, as can be used in some examples of the disclosed technology.

FIGS. 11-13 are flowcharts illustrating example methods of executing and committing instruction blocks out-of-order in a block-based processor, as can be performed in some examples of the disclosed technology.

FIG. 14 is a block diagram illustrating a suitable computing environment for implementing some embodiments of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., as an agent executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive energy-consuming circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write RAMs typically require a mix of replication, multi-cycle operation, clock doubling, bank interleaving, live-value tables, and other expensive techniques.

The disclosed technologies can realize energy efficiency and/or performance enhancement through application of techniques including high instruction-level parallelism (ILP), out-of-order (OoO), superscalar execution, while avoiding substantial complexity and overhead in both processor hardware and associated software. In some examples of the disclosed technology, a block-based processor comprising multiple processor cores uses an Explicit Data Graph Execution (EDGE) ISA designed for area- and energy-efficient, high-ILP execution. In some examples, use of EDGE architectures and associated compilers finesses away much of the register renaming, CAMs, and complexity. In some examples, the respective cores of the block-based processor can store or cache fetched and decoded instructions that may be repeatedly executed (such as loop bodies), and the fetched and decoded instructions can be reused to potentially achieve reduced power and/or increased performance. In some examples, the repeatedly executed instructions can be committed out-of-order.

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an explicit data graph execution instruction set architecture (EDGE ISA) includes information about program control flow that can be used to improve detection of improper control flow instructions, thereby increasing performance, saving memory resources, and/or and saving energy.

In some examples of the disclosed technology, instructions organized within instruction blocks are fetched, executed, and committed atomically. Instructions inside blocks execute in dataflow order, which reduces or eliminates using register renaming and provides power-efficient OoO execution. A compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

Between instruction blocks, instructions can communicate using memory and registers. Thus, by utilizing a hybrid dataflow execution model, EDGE architectures can still support imperative programming languages and sequential memory semantics, but desirably also enjoy the benefits of out-of-order execution with near in-order power efficiency and complexity.

As will be readily understood to one of ordinary skill in the relevant art, a spectrum of implementations of the disclosed technology are possible with various area, performance, and power tradeoffs.

### III. Example Block-Based Processor

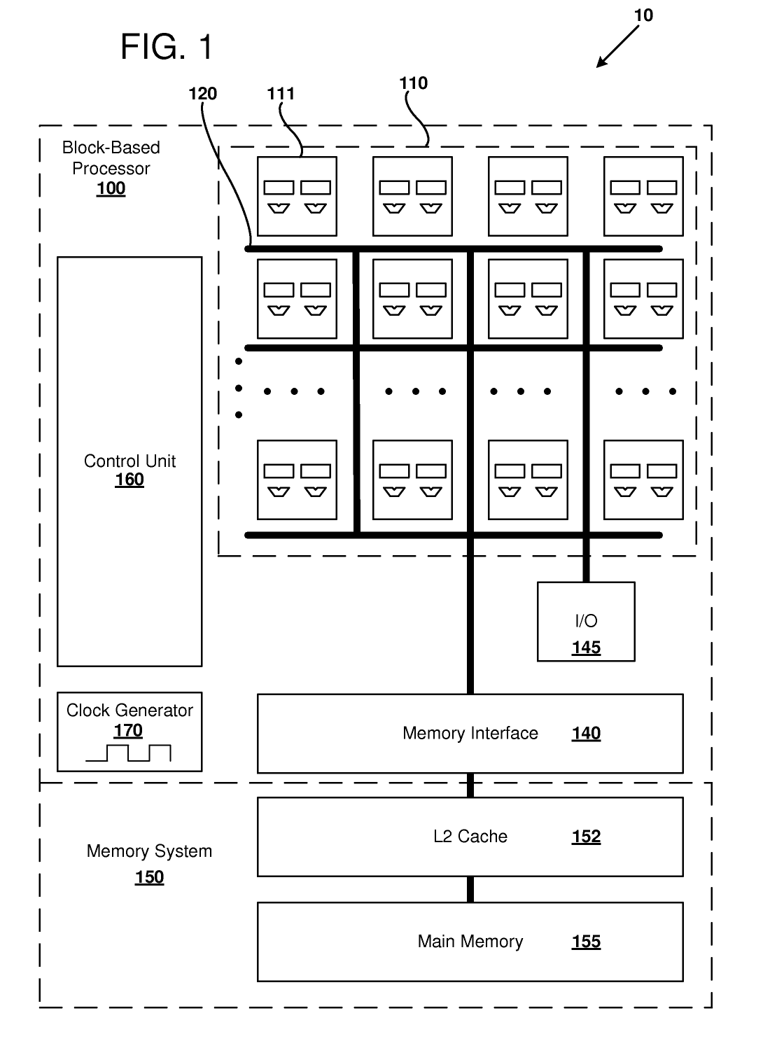

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, interrupts, and other architectural features. The block-based processor includes a plurality of processing cores 110, including a processor core 111.

As shown in FIG. 1, the processor cores are connected to each other via core interconnect 120. The core interconnect 120 carries data and control signals between individual ones of the cores 110, a memory interface 140, and an input/output (I/O) interface 145. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes interface logic that is used to connect to additional memory, for example, memory located on another integrated circuit besides the processor 100. As shown in FIG. 1 an external memory system 150 includes an L2 cache 152 and main memory 155. In some examples the L2 cache can be implemented using static RAM (SRAM) and the main memory 155 can be implemented using dynamic RAM (DRAM). In some examples the memory system 150 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface 140 can include a memory management unit (MMU) for managing and allocating virtual memory, expanding the available main memory 155.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The block-based processor 100 can also include a control unit 160. The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 145, modification of execution flow, and verifying target location(s) of branch instructions, instruction headers, and other changes in control flow. The control unit 160 can also process hardware interrupts, and control reading and writing of special system registers, for example the program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler that is used to allocate instruction blocks to the processor cores 110. As used herein, scheduler allocation refers to hardware for directing operation of an instruction blocks, including initiating instruction block mapping, fetching, decoding, execution, committing, aborting, idling, and refreshing an instruction block. In some examples, the hardware receives signals generated using computer-executable instructions to direct operation of the instruction scheduler. Processor cores 110 are assigned to instruction blocks during instruction block mapping. The recited stages of instruction operation are for illustrative purposes, and in some examples of the disclosed technology, certain operations can be combined, omitted, separated into multiple operations, or additional operations added.

The block-based processor 100 also includes a clock generator 170, which distributes one or more clock signals to various components within the processor (e.g., the cores 110, interconnect 120, memory interface 140, and I/O interface 145). In some examples of the disclosed technology, all of the components share a common clock, while in other examples different components use a different clock, for example, a clock signal having differing clock frequencies. In some examples, a portion of the clock is gated to allowing power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

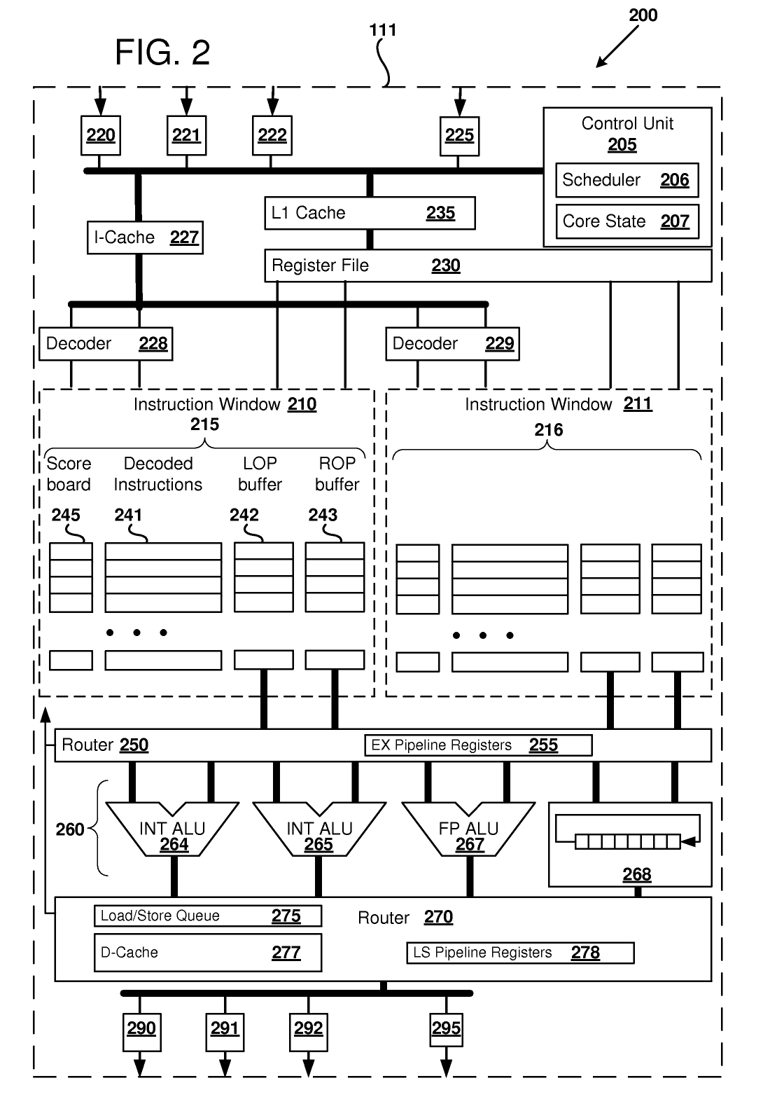

FIG. 2 is a block diagram 200 further detailing an example microarchitecture for the block-based processor 100, and in particular, an instance of one of the block-based processor cores, as can be used in certain examples of the disclosed technology. For ease of explanation, the exemplary block-based processor core is illustrated with five stages: instruction fetch (IF), decode (DE), operand fetch, execute (EX), and memory/data access (LS). However, it will be readily understood by one of ordinary skill in the relevant art that modifications to the illustrated microarchitecture, such as adding/removing stages, adding/removing units that perform operations, and other implementation details can be modified to suit a particular application for a block-based processor.

As shown in FIG. 2, the processor core 111 includes a control unit 205, which can receive control signals from other cores and generate control signals to regulate core operation and schedules the flow of instructions within the core using an instruction scheduler 206. The control unit 205 can include control state 207 for examining core status and/or configuring operating modes of the processor core 111. Operations that can be performed by the control unit 205 and/or instruction scheduler 206 can include allocation and de-allocation of cores for performing instruction processing, control of input data and output data between any of the cores, register files, the memory interface 140, and/or the I/O interface 145. The control unit 205 can also process hardware interrupts, and control reading and writing of special system registers, for example the program counter stored in one or more register file(s). In other examples of the disclosed technology, the control unit 205 and/or instruction scheduler 206 are implemented using a non-block-based processing core (e.g., a general-purpose RISC processing core coupled to memory). In some examples, the control unit 205, instruction scheduler 206, and/or control state 207 are implemented at least in part using one or more of: hardwired finite state machines, programmable microcode, programmable gate arrays, or other suitable control circuits.

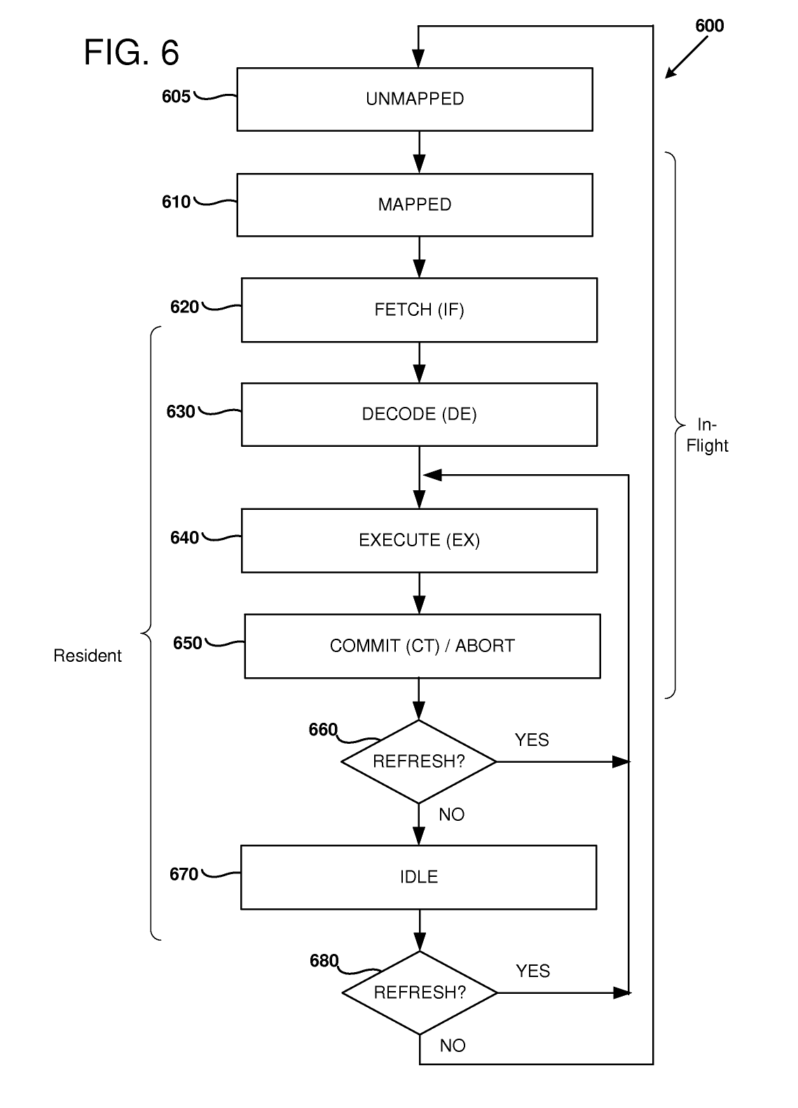

The control state 207 can include control state registers or other logic for modifying and/or examining modes and/or status of an instruction block and/or core status, such as the core states described in further detail below, with reference to FIG. 6. As an example, the core status can indicate whether an instruction block is mapped to the core 111 or an instruction window (e.g., instruction windows 210, 211) of the core 111, whether an instruction block is resident on the core 111, whether an instruction block is executing on the core 111, whether the instruction block is ready to commit, whether the instruction block is performing a commit, and whether the instruction block is idle. As another example, the status of an instruction block can include a token or flag indicating the instruction block is the oldest instruction block executing and a flag indicating the instruction block is executing speculatively.

The control state registers (CSRs) can be mapped to unique memory locations that are reserved for use by the block-based processor. For example, CSRs of the control unit 160 can be assigned to a first range of addresses, CSRs of the memory interface 140 can be assigned to a second range of addresses, a first processor core can be assigned to a third range of addresses, a second processor core can be assigned to a fourth range of addresses, and so forth. In one embodiment, the CSRs can be accessed using general purpose memory read and write instructions of the block-based processor. Additionally or alternatively, the CSRs can be accessed using specific read and write instructions (e.g., the instructions have opcodes different from the memory read and write instructions) for the CSRs. Thus, one core can examine the configuration state of a different core by reading from an address corresponding to the different core's CSRs. Similarly, one core can modify the configuration state of a different core by writing to an address corresponding to the different core's CSRs. In this manner, one core can examine the control state 207 of a different core and one core can modify the control state 207 or modes of a different core.

The control state 207 can include registers or other logic for configuring and/or reconfiguring the core to operate in different operating modes, as described further herein. For example, the control state 207 can include a control register bit, writable through a CSR, that enables a mode to allow the resident instruction block to commit out-of-order. Specifically, when the control bit is programmed with one value (e.g., a one) the instruction block can commit out-of-order, but when the control bit is programmed with the opposite value (e.g., a zero) the instruction block can only commit in-order. Thus, the core 111 can be configured and reconfigured to commit in- or out-of-order by controlling the value of the control bit.

As another example, the control state 207 can include a counter, writable through a CSR, that is representative of a number of times to repeat or refresh the resident instruction block. For example, the counter can be programmed with a number of times to refresh the resident instruction block, and the counter can be decremented each time the resident instruction block is refreshed. The resident instruction block can be refreshed (a new instance of the instruction block can be created) when the counter is non-zero and current instance of the resident instruction block commits. Additionally or alternatively, a repeat control bit can be used to determine whether the resident instruction block can be refreshed. For example, programming a first value (e.g., a one) can configure the core 111 to refresh the instruction block when it commits, and programming a second value (e.g., a zero) can configure the core 111 to not refresh the instruction block when it commits. Instructions within the resident instruction block can be used to determine whether the resident instruction block is to be refreshed and can be used to program the repeat control bit accordingly.

The example processor core 111 includes two instruction windows 210 and 211, each of which can be configured to execute an instruction block. In some examples of the disclosed technology, an instruction block is an atomic collection of block-based-processor instructions that includes an instruction block header and a plurality of one or more instructions. As will be discussed further below, the instruction block header includes information that can be used to further define semantics of one or more of the plurality of instructions within the instruction block. Depending on the particular ISA and processor hardware used, the instruction block header can also be used during execution of the instructions, and to improve performance of executing an instruction block by, for example, allowing for early fetching of instructions and/or data, improved branch prediction, speculative execution, automatic refresh of the instruction block, committing the instruction block out-of-order, improved energy efficiency, and improved code compactness. In other examples, different numbers of instruction windows are possible, such as one, four, eight, or other number of instruction windows.

Each of the instruction windows 210 and 211 can receive instructions and data from one or more of input ports 220, 221, and 222 which connect to an interconnect bus and instruction cache 227, which in turn is connected to the instruction decoders 228 and 229. Additional control signals can also be received on an additional input port 225. Each of the instruction decoders 228 and 229 decodes instruction headers and/or instructions for an instruction block and stores the decoded instructions within a memory store 215 and 216 located in each respective instruction window 210 and 211.

The processor core 111 further includes a register file 230 coupled to an L1 (level one) cache 235. The register file 230 stores data for registers defined in the block-based processor architecture, and can have one or more read ports and one or more write ports. For example, a register file may include two or more write ports for storing data in the register file, as well as having a plurality of read ports for reading data from individual registers within the register file. In some examples, a single instruction window (e.g., instruction window 210) can access only one port of the register file at a time, while in other examples, the instruction window 210 can access one read port and one write port, or can access two or more read ports and/or write ports simultaneously. In some examples, the register file 230 can include 64 registers, each of the registers holding a word of 32 bits of data. (This application will refer to 32-bits of data as a word, unless otherwise specified.) In some examples, some of the registers within the register file 230 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, a processor topology, or other suitable dedicated purpose. In some examples, there are multiple program counter registers, one or each program counter, to allow for concurrent execution of multiple execution threads across one or more processor cores and/or processors. In some examples, program counters are implemented as designated memory locations instead of as registers in a register file. In some examples, use of the system registers may be restricted by the operating system or other supervisory computer instructions. In some examples, the register file 230 is implemented as an array of flip-flops, while in other examples, the register file can be implemented using latches, SRAM, or other forms of memory storage. The ISA specification for a given processor, for example processor 100, specifies how registers within the register file 230 are defined and used.

In some examples, the processor 100 includes a global register file that is shared by a plurality of the processor cores. In some examples, individual register files associated with a processor core can be combined to form a larger file, statically or dynamically, depending on the processor ISA and configuration.

As shown in FIG. 2, the memory store 215 of the instruction window 210 includes a number of decoded instructions 241, a left operand (LOP) buffer 242, a right operand (ROP) buffer 243, and an instruction scoreboard 245. In some examples of the disclosed technology, each instruction of the instruction block is decomposed into a row of decoded instructions, left and right operands, and scoreboard data, as shown in FIG. 2. The decoded instructions 241 can include partially- or fully-decoded versions of instructions stored as bit-level control signals. The operand buffers 242 and 243 store operands (e.g., register values received from the register file 230, data received from memory, immediate operands coded within an instruction, operands calculated by an earlier-issued instruction, or other operand values) until their respective decoded instructions are ready to execute. Instruction operands are read from the operand buffers 242 and 243, not the register file.

The memory store 216 of the second instruction window 211 stores similar instruction information (decoded instructions, operands, and scoreboard) as the memory store 215, but is not shown in FIG. 2 for the sake of simplicity. Instruction blocks can be executed by the second instruction window 211 concurrently or sequentially with respect to the first instruction window, subject to ISA constraints and as directed by the control unit 205.

In some examples of the disclosed technology, front-end pipeline stages IF and DE can run decoupled from the back-end pipelines stages (IS, EX, LS). In one embodiment, the control unit can fetch and decode two instructions per clock cycle into each of the instruction windows 210 and 211. In alternative embodiments, the control unit can fetch and decode one, four, or another number of instructions per clock cycle into a corresponding number of instruction windows. The control unit 205 provides instruction window dataflow scheduling logic to monitor the ready state of each decoded instruction's inputs (e.g., each respective instruction's predicate(s) and operand(s) using the scoreboard 245. When all of the inputs for a particular decoded instruction are ready, the instruction is ready to issue. The control logic 205 then initiates execution of one or more next instruction(s) (e.g., the lowest numbered ready instruction) each cycle and its decoded instruction and input operands are sent to one or more of functional units 260 for execution. The decoded instruction can also encode a number of ready events. The scheduler in the control logic 205 accepts these and/or events from other sources and updates the ready state of other instructions in the window. Thus execution proceeds, starting with the processor core's 111 ready zero input instructions, instructions that are targeted by the zero input instructions, and so forth.

The decoded instructions 241 need not execute in the same order in which they are arranged within the memory store 215 of the instruction window 210. Rather, the instruction scoreboard 245 is used to track dependencies of the decoded instructions and, when the dependencies have been met, the associated individual decoded instruction is scheduled for execution. For example, a reference to a respective instruction can be pushed onto a ready queue when the dependencies have been met for the respective instruction, and instructions can be scheduled in a first-in first-out (FIFO) order from the ready queue. Information stored in the scoreboard 245 can include, but is not limited to, the associated instruction's execution predicate (such as whether the instruction is waiting for a predicate bit to be calculated and whether the instruction executes if the predicate bit is true or false), availability of operands to the instruction, or other prerequisites required before executing the associated individual instruction.

In one embodiment, the scoreboard 245 can include decoded ready state, which is initialized by the instruction decoder 228, and active ready state, which is initialized by the control unit 205 during execution of the instructions. For example, the decoded ready state can encode whether a respective instruction has been decoded, awaits a predicate and/or some operand(s), perhaps via a broadcast channel, or is immediately ready to issue. The active ready state can encode whether a respective instruction awaits a predicate and/or some operand(s), is ready to issue, or has already issued. The decoded ready state can be cleared on a block reset or a block refresh. Upon branching to a new instruction block, the decoded ready state and the active ready state is cleared (a block or core reset). However, when an instruction block is re-executed on the core, such as when it branches back to itself (a block refresh), only active ready state is cleared. Block refreshes can occur immediately (when an instruction block branches to itself) or after executing a number of other intervening instruction blocks. The decoded ready state for the instruction block can thus be preserved so that it is not necessary to re-fetch and decode the block's instructions. Hence, block refresh can be used to save time and energy in loops and other repeating program structures.

The number of instructions that are stored in each instruction window generally corresponds to the number of instructions within an instruction block. In some examples, the number of instructions within an instruction block can be 32, 64, 128, 1024, or another number of instructions. In some examples of the disclosed technology, an instruction block is allocated across multiple instruction windows within a processor core. In some examples, the instruction windows 210, 211 can be logically partitioned so that multiple instruction blocks can be executed on a single processor core. For example, one, two, four, or another number of instruction blocks can be executed on one core. The respective instruction blocks can be executed concurrently or sequentially with each other.

Instructions can be allocated and scheduled using the control unit 205 located within the processor core 111. The control unit 205 orchestrates fetching of instructions from memory, decoding of the instructions, execution of instructions once they have been loaded into a respective instruction window, data flow into/out of the processor core 111, and control signals input and output by the processor core. For example, the control unit 205 can include the ready queue, as described above, for use in scheduling instructions. The instructions stored in the memory store 215 and 216 located in each respective instruction window 210 and 211 can be executed atomically. Thus, updates to the visible architectural state (such as the register file 230 and the memory) affected by the executed instructions can be buffered locally within the core 111 until the instructions are committed.

The control unit 205 can determine when instructions are ready to be committed, sequence the commit logic, and issue a commit signal. For example, a commit phase for an instruction block can begin when dependencies of the instruction block are satisfied and operations of the instruction block are complete. As one example, the dependencies of the instruction block can be satisfied when the instruction blocks are committing in sequential program order and all preceding instruction blocks have committed (e.g., the current instruction block is the oldest instruction block) and/or when the core 111 is configured to commit the resident instruction block out-of-order. As another example, the operations of the instruction block can be completed when all register writes are buffered, all writes to memory are buffered, and a branch target is calculated. The instruction block can be committed when updates to the visible architectural state are complete. For example, an instruction block can be committed when the register writes are written to the register file, the stores are sent to a load/store unit or memory controller, and the commit signal is generated. The control unit 205 also controls, at least in part, allocation of functional units 260 to each of the respective instructions windows.

As shown in FIG. 2, a first router 250, which has a number of execution pipeline registers 255, is used to send data from either of the instruction windows 210 and 211 to one or more of the functional units 260, which can include but are not limited to, integer ALUs (arithmetic logic units) (e.g., integer ALUs 264 and 265), floating point units (e.g., floating point ALU 267), shift/rotate logic (e.g., barrel shifter 268), or other suitable execution units, which can including graphics functions, physics functions, and other mathematical operations. Data from the functional units 260 can then be routed through a second router 270 to outputs 290, 291, and 292, routed back to an operand buffer (e.g. LOP buffer 242 and/or ROP buffer 243), or fed back to another functional unit, depending on the requirements of the particular instruction being executed. The second router 270 can include a load/store queue 275, which can be used to issue memory instructions, a data cache 277, which stores data being output from the core to memory, and load/store pipeline register 278.

The core also includes control outputs 295 which are used to indicate, for example, when execution of all of the instructions for one or more of the instruction windows 210 or 211 has completed. When execution of an instruction block is complete, the instruction block is designated as “committed” and signals from the control outputs 295 can in turn can be used by other cores within the block-based processor 100 and/or by the control unit 160 to initiate scheduling, fetching, and execution of other instruction blocks. Both the first router 250 and the second router 270 can send data back to the instruction (for example, as operands for other instructions within an instruction block).

As will be readily understood to one of ordinary skill in the relevant art, the components within an individual core 111 are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window (e.g., instruction window 210) and control logic 205 of the processor cores 110. The area, clock period, capabilities, and limitations substantially determine the realized performance of the individual cores 110 and the throughput of the block-based processor 110.

The instruction scheduler 206 can have diverse functionality. In certain higher performance examples, the instruction scheduler is highly concurrent. For example, each cycle, the decoder(s) write instructions' decoded ready state and decoded instructions into one or more instruction windows, selects the next instruction to issue, and, in response the back end sends ready events—either target-ready events targeting a specific instruction's input slot (predicate, left operand, right operand, etc.), or broadcast-ready events targeting all instructions. The per-instruction ready state bits, together with the decoded ready state can be used to determine that the instruction is ready to issue.

In some examples, the instruction scheduler 206 is implemented using storage (e.g., first-in first-out (FIFO) queues, content addressable memories (CAMs)) storing data indicating information used to schedule execution of instruction blocks according to the disclosed technology. For example, data regarding instruction dependencies, transfers of control, speculation, branch prediction, and/or data loads and stores are arranged in storage to facilitate determinations in mapping instruction blocks to processor cores. For example, instruction block dependencies can be associated with a tag that is stored in a FIFO or CAM and later accessed by selection logic used to map instruction blocks to one or more processor cores. In some examples, the instruction scheduler 206 is implemented using a general purpose processor coupled to memory, the memory being configured to store data for scheduling instruction blocks. In some examples, instruction scheduler 206 is implemented using a special purpose processor or using a block-based processor core coupled to the memory. In some examples, the instruction scheduler 206 is implemented as a finite state machine coupled to the memory. In some examples, an operating system executing on a processor (e.g., a general purpose processor or a block-based processor core) generates priorities, predictions, and other data that can be used at least in part to schedule instruction blocks with the instruction scheduler 206. As will be readily apparent to one of ordinary skill in the relevant art, other circuit structures, implemented in an integrated circuit, programmable logic, or other suitable logic can be used to implement hardware for the instruction scheduler 206.

In some cases, the scheduler 206 accepts events for target instructions that have not yet been decoded and must also inhibit reissue of issued ready instructions. Instructions can be non-predicated, or predicated (based on a true or false condition). A predicated instruction does not become ready until it is targeted by another instruction's predicate result, and that result matches the predicate condition. If the associated predicate does not match, the instruction never issues. In some examples, predicated instructions may be issued and executed speculatively. In some examples, a processor may subsequently check that speculatively issued and executed instructions were correctly speculated. In some examples a misspeculated issued instruction and the specific transitive closure of instructions in the block that consume its outputs may be re-executed, or misspeculated side effects annulled. In some examples, discovery of a misspeculated instruction leads to the complete roll back and re-execution of an entire block of instructions.

### V. Example Stream of Instruction Blocks

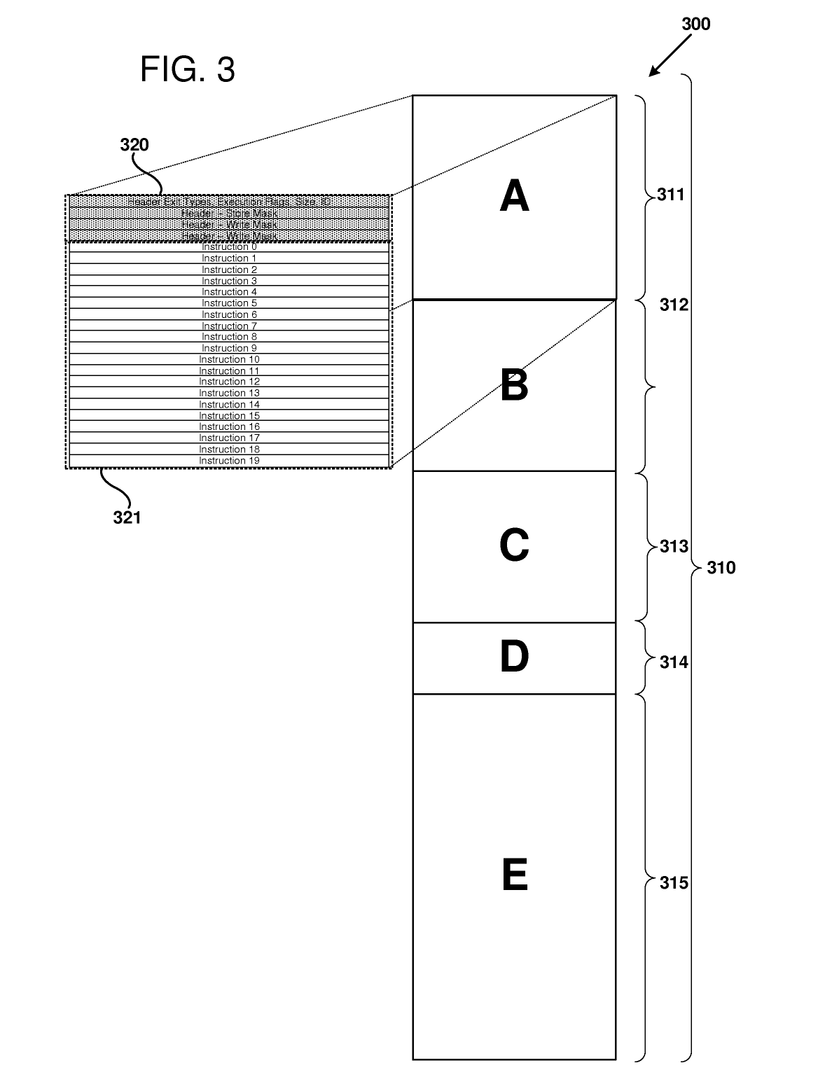

Turning now to the diagram 300 of FIG. 3, a portion 310 of a stream of block-based instructions, including a number of variable length instruction blocks 311-315 (A-E) is illustrated. The stream of instructions can be used to implement user application, system services, or any other suitable use. In the example shown in FIG. 3, each instruction block begins with an instruction header, which is followed by a varying number of instructions. For example, the instruction block 311 includes a header 320 and twenty instructions 321. The particular instruction header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an ID bit which indicates that the header is an instruction header and not an instruction. The instruction header 320 also includes an indication of the instruction block size. The instruction block size can be in larger chunks of instructions than one, for example, the number of 4-instruction chunks contained within the instruction block. In other words, the size of the block is shifted 4 bits in order to compress header space allocated to specifying instruction block size. Thus, a size value of 0 indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include execution flags, which indicate special instruction execution requirements. For example, branch prediction or memory dependence prediction can be inhibited for certain instruction blocks, depending on the particular application. As another example, a flag in the header may indicate that the instruction block can be refreshed and/or committed out-of-order. As another example, a flag in the header may indicate that the instruction block cannot execute a new instruction block until the instruction block is synchronized. For example, the processor core can wait to commit or stay in the idle state after a commit until a synchronization signal or message is provided to the processor core. The signal or message can be provided by a different processor core or the control unit 205, for example.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, branch prediction, control flow determination, and/or bad jump detection. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The instruction block header 320 also includes a store mask which identifies the load-store queue identifiers that are assigned to store operations. The instruction block header can also include a write mask, which identifies which global register(s) the associated instruction block will write. The associated register file must receive a write to each entry before the instruction block can complete. In some examples a block-based processor architecture can include not only scalar instructions, but also single-instruction multiple-data (SIMD) instructions, that allow for operations with a larger number of data operands within a single instruction.

### VI. Example Block Instruction Target Encoding

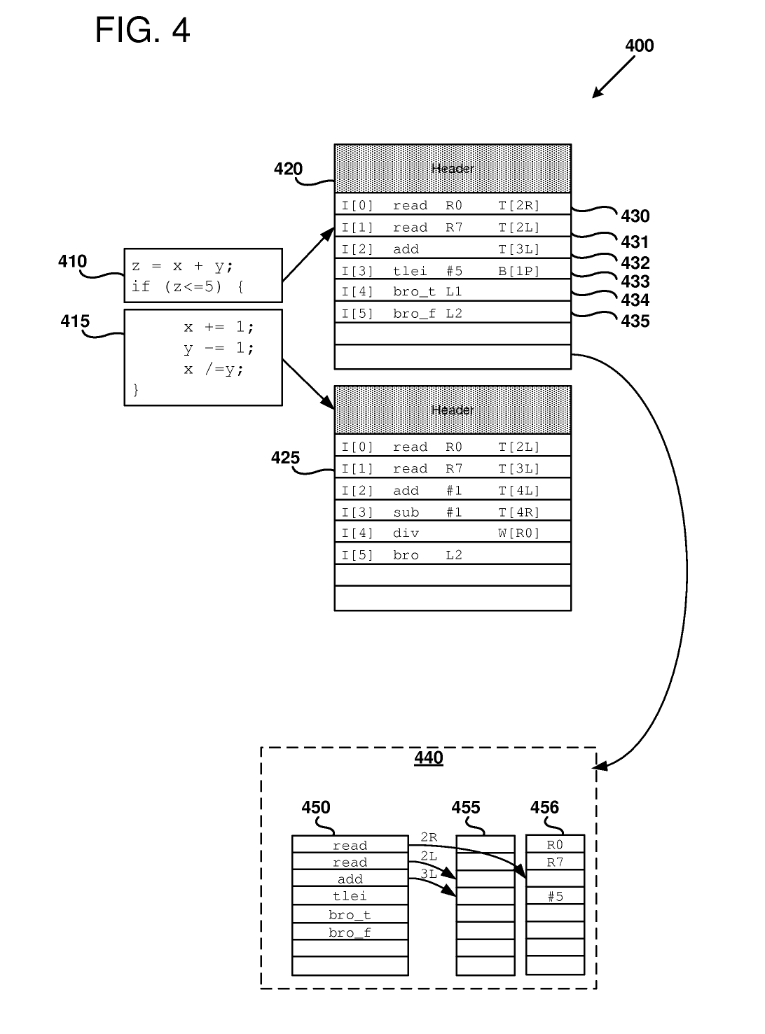

FIG. 4 is a diagram 400 depicting an example of two portions 410 and 415 of C language source code and their respective instruction blocks 420 and 425 (in assembly language), illustrating how block-based instructions can explicitly encode their targets. The high-level C language source code can be translated to the low-level assembly language and machine code by a compiler whose target is a block-based processor. A high-level language can abstract out many of the details of the underlying computer architecture so that a programmer can focus on functionality of the program. In contrast, the machine code encodes the program according to the target computer's ISA so that it can be executed on the target computer, using the computer's hardware resources. Assembly language is a human-readable form of machine code.

In this example, the first two READ instructions 430 and 431 target the right (T[2R]) and left (T[2L]) operands, respectively, of the ADD instruction 432. In the illustrated ISA, the read instruction is the only instruction that reads from the global register file; however any instruction can target, the global register file. When the ADD instruction 432 receives the result of both register reads it will become ready and execute.

When the TLEI (test-less-than-equal-immediate) instruction 433 receives its single input operand from the ADD, it will become ready and execute. The test then produces a predicate operand that is broadcast on channel one (B[1P]) to all instructions listening on the broadcast channel, which in this example are the two predicated branch instructions (BRO_T 434 and BRO_F 435). The branch that receives a matching predicate will fire.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READ 430 and READ 431 are ready to issue, as they have no input dependencies. As they issue and execute, the values read from registers R6 and R7 are written into the right and left operand buffers of ADD 432, marking the left and right operands of ADD 432 “ready.” As a result, the ADD 432 instruction becomes ready, issues to an ALU, executes, and the sum is written to the left operand of TLEI 433.

As a comparison, a conventional out-of-order RISC or CISC processor would dynamically build the dependence graph at runtime, using additional hardware complexity, power, area and reducing clock frequency and performance. However, the dependence graph is known statically at compile time and an EDGE compiler can directly encode the producer-consumer relations between the instructions through the ISA, freeing the microarchitecture from rediscovering them dynamically. This can potentially enable a simpler microarchitecture, reducing area, power and boosting frequency and performance.

### VII. Example Block-Based Instruction Formats

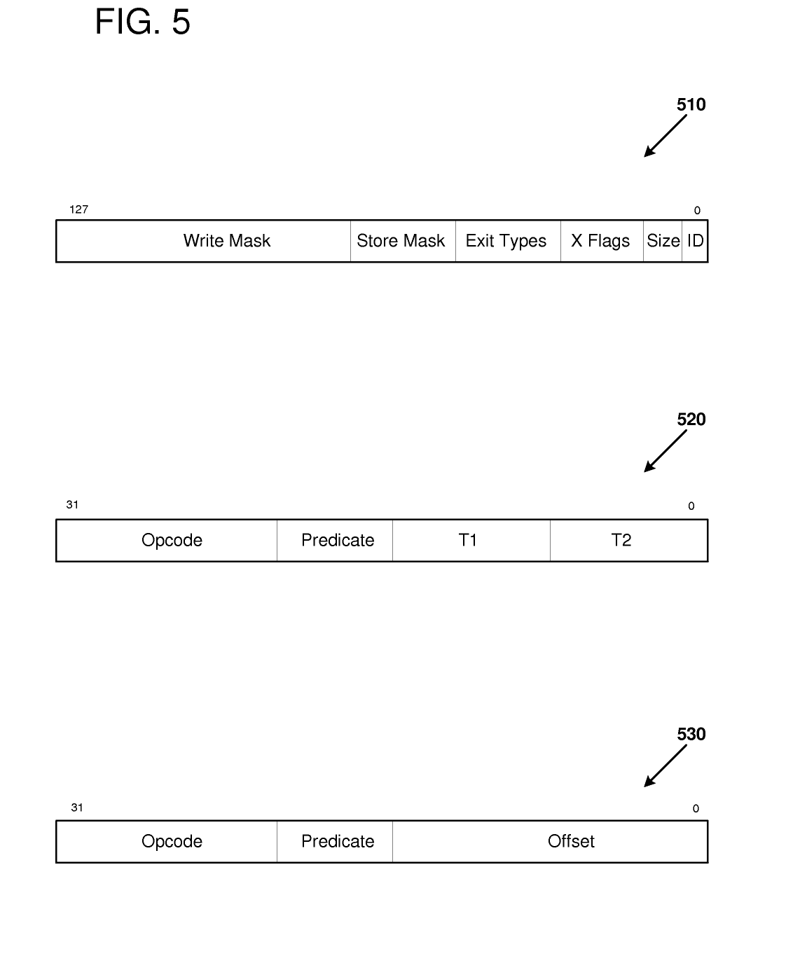

FIG. 5 is a diagram illustrating generalized examples of instruction formats for an instruction header 510, a generic instruction 520, and a branch instruction 530. Each of the instruction headers or instructions is labeled according to the number of bits. For example the instruction header 510 includes four 32-bit words and is labeled from its least significant bit (lsb) (bit 0) up to its most significant bit (msb) (bit 127). As shown, the instruction header includes a write mask field, a store mask field, a number of exit type fields, a number of execution flag fields, an instruction block size field, and an instruction header ID bit (the least significant bit of the instruction header).

The exit type fields include data that can be used to indicate the types of control flow and/or synchronization instructions encoded within the instruction block. For example, the exit type fields can indicate that the instruction block includes one or more of the following: sequential branch instructions, offset branch instructions, indirect branch instructions, call instructions, return instructions, and/or break instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions. In some examples, up to six exit types can be encoded in the exit type fields, and the correspondence between fields and corresponding explicit or implicit control flow instructions can be determined by, for example, examining control flow instructions in the instruction block.

The illustrated generic block instruction 520 is stored as one 32-bit word and includes an opcode field, a predicate field, a broadcast ID field (BID), a first target field (T1), and a second target field (T2). For instructions with more consumers than target fields, a compiler can build a fanout tree using move instructions, or it can assign high-fanout instructions to broadcasts. Broadcasts support sending an operand over a lightweight network to any number of consumer instructions in a core. A broadcast identifier can be encoded in the generic block instruction 520.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the operation(s) performed by the instruction 520, such as memory read/write, register load/store, add, subtract, multiply, divide, shift, rotate, system operations, or other suitable instructions. The predicate field specifies the condition under which the instruction will execute. For example, the predicate field can specify the value “true,” and the instruction will only execute if a corresponding condition flag matches the specified predicate value. In some examples, the predicate field specifies, at least in part, which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specifying the instructions to which the results of the block-based instruction are sent. For example, an ADD instruction at instruction slot 5 can specify that its computed result will be sent to instructions at slots 3 and 10. Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. For example, a BRO_F (predicated false) instruction will issue if it is sent a false predicate value.

It should be readily understood that, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

### VIII. Example States of a Processor Core

FIG. 6 is a flowchart illustrating an example of a progression of states 600 of a processor core of a block-based computer. The block-based computer is composed of multiple processor cores that are collectively used to run or execute a software program. The program can be written in a variety of high-level languages and then compiled for the block-based processor using a compiler that targets the block-based processor. The compiler can emit code that, when run or executed on the block-based processor, will perform the functionality specified by the high-level program. The compiled code can be stored in a computer-readable memory that can be accessed by the block-based processor. The compiled code can include a stream of instructions grouped into a series of instruction blocks. During execution, one or more of the instruction blocks can be executed by the block-based processor to perform the functionality of the program. Typically, the program will include more instruction blocks than can be executed on the cores at any one time. Thus, blocks of the program are mapped to respective cores, the cores perform the work specified by the blocks, and then the blocks on respective cores are replaced with different blocks until the program is complete. Some of the instruction blocks may be executed more than once, such as during a loop or a subroutine of the program. An “instance” of an instruction block can be created for each time the instruction block will be executed. Thus, each repetition of an instruction block can use a different instance of the instruction block. As the program is run, the respective instruction blocks can be mapped to and executed on the processor cores based on architectural constraints, available hardware resources, and the dynamic flow of the program. During execution of the program, the respective processor cores can transition through a progression of states 600, so that one core can be in one state and another core can be in a different state.

At 605, a state of a respective processor core can be unmapped. An unmapped processor core is a core that is not currently assigned to execute an instance of an instruction block. For example, the processor core can be unmapped before the program begins execution on the block-based computer. As another example, the processor core can be unmapped after the program begins executing but not all of the cores are being used. In particular, the instruction blocks of the program are executed, at least in part, according to the dynamic flow of the program. Some parts of the program may flow generally serially or sequentially, such as when a later instruction block depends on results from an earlier instruction block. Other parts of the program may have a more parallel flow, such as when multiple instruction blocks can execute at the same time without using the results of the other blocks executing in parallel. Fewer cores can be used to execute the program during more sequential streams of the program and more cores can be used to execute the program during more parallel streams of the program.

At 610, the state of the respective processor core can be mapped. A mapped processor core is a core that is currently assigned to execute an instance of an instruction block. When the instruction block is mapped to a specific processor core, the instruction block is in-flight. An in-flight instruction block is a block that is targeted to a particular core of the block-based processor, and the block will be or is executing, either speculatively or non-speculatively, on the particular processor core. In particular, the in-flight instruction blocks correspond to the instruction blocks mapped to processor cores in states 610-650. A block executes non-speculatively when it is known during mapping of the block that the program will use the work provided by the executing instruction block. A block executes speculatively when it is not known during mapping whether the program will or will not use the work provided by the executing instruction block. Executing a block speculatively can potentially increase performance, such as when the speculative block is started earlier than if the block were to be started after or when it is known that the work of the block will be used. However, executing speculatively can potentially increase the energy used when executing the program, such as when the speculative work is not used by the program.

A block-based processor includes a finite number of homogeneous or heterogeneous processor cores. A typical program can include more instruction blocks than can fit onto the processor cores. Thus, the respective instruction blocks of a program will generally share the processor cores with the other instruction blocks of the program. In other words, a given core may execute the instructions of several different instruction blocks during the execution of a program. Having a finite number of processor cores also means that execution of the program may stall or be delayed when all of the processor cores are busy executing instruction blocks and no new cores are available for dispatch. When a processor core becomes available, an instance of an instruction block can be mapped to the processor core.

An instruction block scheduler can assign which instruction block will execute on which processor core and when the instruction block will be executed. The mapping can be based on a variety of factors, such as a target energy to be used for the execution, the number and configuration of the processor cores, the current and/or former usage of the processor cores, the dynamic flow of the program, whether speculative execution is enabled, a confidence level that a speculative block will be executed, and other factors. An instance of an instruction block can be mapped to a processor core that is currently available (such as when no instruction block is currently executing on it). In one embodiment, the instance of the instruction block can be mapped to a processor core that is currently busy (such as when the core is executing a different instance of an instruction block) and the later-mapped instance can begin when the earlier-mapped instance is complete.

At 620, the state of the respective processor core can be fetch. For example, the IF pipeline stage of the processor core can be active during the fetch state. An instruction block that is being fetched is a block that is being transferred from memory (such as the L1 cache, the L2 cache, or main memory) to the processor core. For example, the instructions of the instruction block can be loaded into a buffer or registers of the processor core. The fetch state can be multiple cycles long and can overlap with the decode (630) and execute (640) states when the processor core is pipelined. When instructions of the instruction block are loaded onto the processor core, the instruction block is resident on the processor core. The instruction block is partially resident when some, but not all, instructions of the instruction block are loaded. The instruction block is fully resident when all instructions of the instruction block are loaded. The instruction block will be resident on the processor core until the processor core is reset or a different instruction block is fetched onto the processor core. In particular, an instruction block is resident in the processor core when the core is in states 620-670.

At 630, the state of the respective processor core can be decode. For example, the DE pipeline stage of the processor core can be active during the fetch state. During the decode state, instructions of the instruction block are being decoded so that they can be stored in the memory store of the instruction window of the processor core. In particular, the instructions can be transformed from relatively compact machine code, to a less compact representation that can be used to control hardware resources of the processor core. The decode state can be multiple cycles long and can overlap with the fetch (620) and execute (640) states when the processor core is pipelined. After an instruction of the instruction block is decoded, it can be executed when all dependencies of the instruction are met.

At 640, the state of the respective processor core can be execute. During the execute state, instructions of the instruction block are being executed. In particular, the EX and/or LS pipeline stages of the processor core can be active during the execute state. The instruction block can be executing speculatively or non-speculatively. A speculative block can execute to completion or it can be terminated prior to completion, such as when it is determined that work performed by the speculative block will not be used. When an instruction block is terminated, the processor can transition to the abort state. A speculative block can complete when it is determined the work of the block will be used, all register writes are buffered, all writes to memory are buffered, and a branch target is calculated, for example. A non-speculative block can execute to completion when all register writes are buffered, all writes to memory are buffered, and a branch target is calculated, for example. The execute state can be multiple cycles long and can overlap with the fetch (620) and decode (630) states when the processor core is pipelined. When the instruction block is complete, the processor can transition to the commit state.

At 650, the state of the respective processor core can be commit or abort. During commit, the work of the instructions of the instruction block can be atomically committed so that other blocks can use the work of the instructions. In particular, the commit state can include a commit phase where locally buffered architectural state is written to architectural state that is visible to or accessible by other processor cores. When the visible architectural state is updated, a commit signal can be issued and the processor core can be released so that another instruction block can be executed on the processor core. During the abort state, the pipeline of the core can be halted to reduce dynamic power dissipation. In some applications, the core can be power gated to reduce static power dissipation. At the conclusion of the commit/abort states, the processor core can receive a new instruction block to be executed on the processor core, the core can be refreshed, the core can be idled, or the core can be reset.

The respective processor cores can be configured to commit instruction blocks either in-order or out-of-order. For example, the processor cores can include configurable state to determine whether instruction blocks will be committed in-order (in-order mode) or committed out-of-order (out-of-order mode). The default state of the processor cores can be to commit the instruction blocks in-order. As described further below, a header encoding or a signal from another core can be used to program one or more processor cores to commit a first group of instruction blocks out-of-order for a portion of the program. The one or more processor cores can then be reconfigured to commit a second group of instruction blocks in-order, such as by synchronizing the processor cores when the first group of instruction blocks have been committed.

The instruction blocks will be committed in program order when the processor core is configured to be in the in-order mode. The program order will occur in accordance with a dependence graph of the program, where the nodes of the graph are the instruction blocks and the directed edges of the graphs are ordered relations (e.g., branches) among the instruction blocks. Within a single thread of the program, the instruction blocks can be sequentially committed in program order based on data, control, and resource constraints of the block-based processor. Thus, when the instruction blocks are committed in-order, if one instruction block stalls (such as due to resource contention with another thread, or due to long memory read latency), the instruction blocks following after the stalled instruction block (later in the sequence) will be delayed behind the stalled instruction block.

During execution of the program, program order can be maintained by allowing only the oldest instruction block to commit For example, a token can be used to identify the oldest instruction block. Specifically, when the first instruction block of the program is mapped and/or fetched, the processor core associated with the first instruction block can receive the token, and the token can be associated with the processor core and the instruction block until the block is committed. As one example, an instruction header of the first instruction block of the program can be encoded with the token. As another example, an operating system and/or the instruction block scheduler can provide the token, such as via a control signal or by programming a local register, to the processor core associated with the first instruction block. Receipt of the token can be recorded by setting a local register within the processor block, for example. When the instruction block having the token commits, the token can be passed to the processor core executing the targeted instruction block (the branch target), and the token status can be cleared for the processor performing the commit Thus, the token can be passed from one instruction block to the next instruction block following the program order along the edges of the dependence graph. Instruction blocks without the token can be delayed or prevented from committing. For example, instruction blocks later in program order can be speculatively executed before an earlier block commits, but the later, speculative blocks can be delayed from committing until the earlier block commits and passes the token to the later blocks.

The instruction blocks can be committed out-of-order relative to the program order when the processor core is configured to be in the out-of-order mode. In the out-of-order mode, the instruction block can commit when the instruction block has finished execution and commit resources are available, without waiting for the token. For example, instruction blocks that are independent can be committed out-of-order without affecting the correctness of the program. When independent instruction blocks are executing in parallel (e.g., on different processor cores), the blocks can commit in any order, regardless of the order they were emitted from the compiler. Thus, a stalled independent block that was emitted before a later independent block is less likely to block or delay the committing of the later independent block.

At 660, it can be determined if the instruction block resident on the processor core can be refreshed. As used herein, an instruction block refresh or a processor core refresh means enabling the processor core to re-execute one or more instruction blocks that are resident on the processor core. In one embodiment, refreshing a core can include resetting the active-ready state for one or more instruction blocks. It may be desirable to re-execute the instruction block on the same processor core when the instruction block is part of a loop or a repeated sub-routine or when a speculative block was terminated and is to be re-executed. The decision to refresh can be made by the processor core itself (contiguous reuse) or by outside of the processor core (non-contiguous reuse). For example, the decision to refresh can come from another processor core or a control core performing instruction block scheduling. There can be a potential energy savings when an instruction block is refreshed on a core that already executed the instruction as opposed to executing the instruction block on a different core. Energy is used to fetch and decode the instructions of the instruction block, but a refreshed block can save most of the energy used in the fetch and decode states by bypassing these states. In particular, a refreshed block can re-start at the execute state (640) because the instructions have already been fetched and decoded by the core. When a block is refreshed, the decoded instructions and the decoded ready state can be maintained while the active ready state is cleared. The decision to refresh an instruction block can occur as part of the commit operations or at a later time. If an instruction block is not refreshed, the processor core can be idled.

At 670, the state of the respective processor core can be idle. The performance and power consumption of the block-based processor can potentially be adjusted or traded off based on the number of processor cores that are active at a given time. For example, performing speculative work on concurrently running cores may increase the speed of a computation but increase the power if the speculative misprediction rate is high. As another example, immediately allocating new instruction blocks to processors after committing or aborting an earlier executed instruction block may increase the number of processors executing concurrently, but may reduce the opportunity to reuse instruction blocks that were resident on the processor cores. Reuse may be increased when a cache or pool of idle processor cores is maintained. For example, when a processor core commits a commonly used instruction block, the processor core can be placed in the idle pool so that the core can be refreshed the next time that the same instruction block is to be executed. As described above, refreshing the processor core can save the time and energy used to fetch and decode the resident instruction block. The instruction blocks/processor cores to place in an idle cache can be determined based on a static analysis performed by the compiler or a dynamic analysis performed by the instruction block scheduler. For example, a compiler hint indicating potential reuse of the instruction block can be placed in the header of the block and the instruction block scheduler can use the hint to determine if the block will be idled or reallocated to a different instruction block after committing the instruction block. When idling, the processor core can be placed in a low-power state to reduce dynamic power consumption, for example.

At 680, it can be determined if the instruction block resident on the idle processor core can be refreshed. If the core is to be refreshed, the block refresh signal can be asserted and the core can transition to the execute state (640). If the core is not going to be refreshed, the block reset signal can be asserted and the core can transition to the unmapped state (605). When the core is reset, the core can be put into a pool with other unmapped cores so that the instruction block scheduler can allocate a new instruction block to the core.

### IX. Examples of Block-Based Compiler Methods

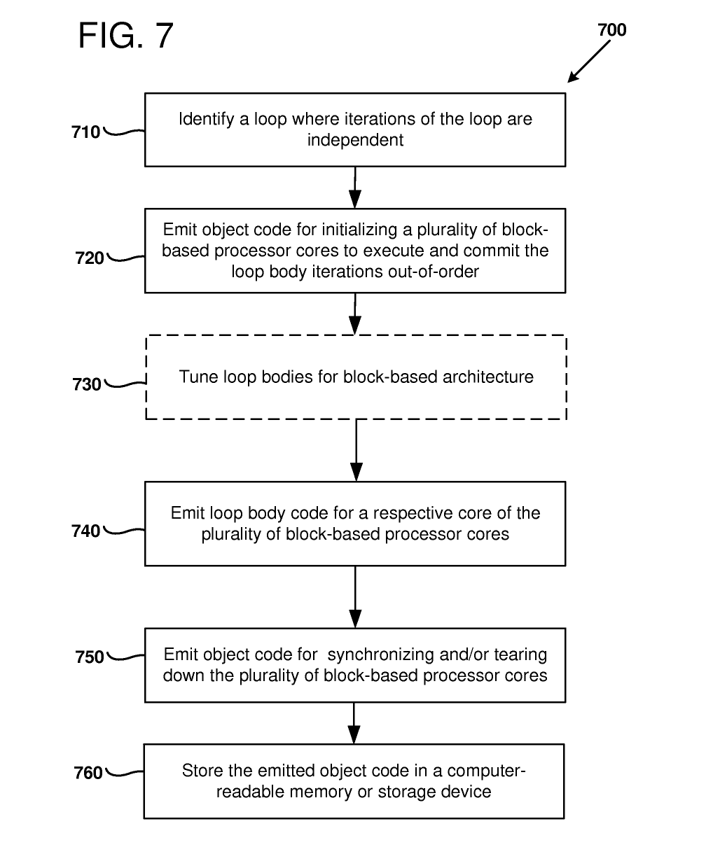

FIG. 7 is a flowchart illustrating an example method 700 for compiling to a block-based computer architecture. The method 700 can be implemented in software of a compiler executing on a block-based processor or a conventional processor. The compiler can transform high-level source code (such as C, C++, or Java) of a program, in one or more phases or passes, into low-level object or machine code that is executable on the targeted block-based processor. The machine code can be stored into a memory of the block-based processor so that the block-based processor can execute the program.

The compiler can generate the machine code as a sequential stream of instructions which can be grouped into instruction blocks according to the block-based computer's hardware resources and the data and control flow of the code. For example, a given instruction block can include a single basic block, a portion of a basic block, or multiple basic blocks, so long as the instruction block can be executed within the constraints of the ISA and the hardware resources of the targeted computer. A basic block can be a block of code where control can only enter the block at the first instruction of the block and control can only leave the block at the last instruction of the basic block. Thus, a basic block is a sequence of instructions that are executed together.

At 710, a loop can be identified where iterations of the loop are independent. A loop or iterative statement can include a control expression and a loop body. The control expression can be evaluated before or after executing the loop body. The loop body can be executed repeatedly until the control expression is evaluated to be an exit condition. As one example, loops in the C language include for, while, and do statements. As a specific example, a for loop can include an initialization expression for setting an initial value of a loop or induction variable; a control expression for determining whether the loop should be exited; an expression for modifying the induction variable; and a loop body that is repeatedly executed until the control expression is satisfied. The loop can be identified during a syntax analysis or parsing phase of the compiler, such as by detecting a keyword and grammar of the loop.

A set of rules or conditions can be used to determine when the different iterations of the loop are independent and can execute in parallel. For example, the set of conditions can indicate that two processes (e.g., loop iterations) are independent when there is no intersection of the input set of the first process and the output set of the second process; when there is no intersection of the input set of the second process and the output set of the first process; and when there is no intersection of the output sets of the first and second processes. When the load and store locations of a program can be statically determined by the compiler, the compiler can analyze each loop of the program to determine if the set of conditions are satisfied and identify whether the loop iterations are independent. Additionally or alternatively, the programmer can use a compiler directive or a source code keyword to identify the independent loop iterations. When the compiler detects the compiler directive or the source code keyword (such as during syntax analysis of the source code), the loop iterations can be flagged as independent of one another.

When a loop having independent loop iterations is detected, the loop iterations can be executed in parallel and committed out-of-order on different processor cores. The compiler can generate and emit different instruction blocks to: initialize or enable the processor cores to execute and commit the loop iterations out-of-order (720); execute and commit the loop bodies (740); and synchronize and reconfigure the processor cores to commit blocks in-order (750). By executing and committing the independent loop bodies of a given loop in parallel on different processor cores, the speed to complete the loop can potentially be increased since one stalled loop iteration may not block the execution and committing of other loop iterations. The speed-up can be proportional to the number of processor cores that are used to execute the loop bodies. As a specific example, a loop having 1000 iterations can be sped up by about four times by executing the loop bodies on four different processor cores, where each processor core can execute 250 iterations of the loop.

At 720, object code can be emitted for initializing a plurality of block-based processor cores to execute and commit the loop body iterations out-of-order. The initialization code can be emitted as a single instruction block or multiple instruction blocks. Initialization code can include code for masking interrupts, reading a dataset from storage, allocating memory, locking pages in memory, determining a number and identity of processor cores associated with an executing thread, determining a number of processor cores that can be used to execute the loop, reserving processor cores, configuring processor cores, initiating execution on processor cores, and/or setting up a synchronization point. The instruction block(s) containing the initialization code can branch to the instruction block(s) of the loop bodies or to instruction block(s) containing synchronization code.

Interrupts may be masked during execution of the loop so that architectural state of the block-based process can be in a known state when the interrupt is serviced. Thus, from the perspective of the interrupt, the entire loop will be an atomic operation. The memory locations associated with an input dataset can be read from a hard disk or other storage device and paged into memory; memory can be allocated for an output set of the loop; and the memory associated with the input and output datasets can be locked in memory to reduce or eliminate the risk of a page fault occurring during the loop.

The number of cores used to execute the loop can be based on a number of factors, such as the number of iterations of the loop, the number of processor cores available for a thread of execution, and so forth. The number and identity of processor cores used to execute the loop can be determined statically at compile-time or dynamically at run-time. For example, the emitted object code can include code to reserve predetermined processor cores to execute the loop. As another example, the emitted object code can include code for determining a number and identity of processor cores associated with the currently executing thread. For example, the code can examine a data structure storing the specific processors associated with the thread, or a thread identifier can be read from the state of one or more of the processor cores and compared against an identifier of the currently executing thread. A set of processor cores from the pool of processor cores associated with the thread can be reserved to execute the loop bodies. Reserving the processor cores can include mapping the loop body to the respective processor cores, for example.

Configuring the processor cores can include setting configuration state within the processor core. For example, state can be configured to enable committing the loop bodies out-of-order. As another example, a counter can be programmed with a number of times to repeat the loop body, or a repeat control bit can be initialized to enable repeating of the loop body. The emitted initialization code can include code to explicitly initiate execution on the processor cores, or the processor cores can automatically begin execution after the loop body is mapped to the processor cores.

At 730, the loop bodies can be optionally tuned for the block-based architecture. For example, the processor cores can include a fixed number of resources, such as one or more instruction windows, a fixed number of load and store queue entries, and so forth. The loop body may have fewer instructions than are available within an instruction window. For example, a loop body may include eight instructions and the instruction window may have storage capacity for thirty-two decoded instructions. Tuning can include unrolling the loop by combining multiple iterations of the loop body within a larger loop body. By unrolling the loop, the number of instructions within a loop body can be increased and the instruction window resource can potentially be more efficiently utilized. As a specific example, the eight instruction loop body can be unrolled three or four times to better utilize an instruction window having storage capacity for thirty-two decoded instructions.

At 740, object code for the loop body can be emitted for a respective core of the plurality of block-based processor cores. The emitted code can be an instruction block including an instruction header and one or more instructions. The instruction header can include control information such as a flag to enable out-of-order commits, a number of iterations, a synchronization target address, and so forth. The object code for the loop bodies associated with each core can be the same or different. For example, the number of iterations can be different for different respective processor cores, such as when the number of iterations is not evenly divisible by the number of processor cores used to execute the loop bodies. The loop bodies can branch to a synchronization block or can halt when all iterations of the loop are committed.

At 750, object code can be emitted for synchronizing and/or tearing down the plurality of block-based processor cores. For example, the synchronization and tear-down code can be emitted as a single instruction block. Synchronizing can include creating a synchronization barrier to synchronize the plurality of the processor cores that were executing and committing the loop bodies out-of-order. For example, the synchronizing can include waiting for all of the processor cores executing the loop bodies to complete. As one example, the processing state associated with each of the processor cores executing the loop bodies can be polled until the state for all of the processor cores is idle. As another example, each of the processor cores executing a loop body can send a signal or message to the synchronizing core, and when signals or messages are received from all of the processor cores, the synchronization code can continue. Tearing down the plurality of block-based processor cores can include reconfiguring the cores to commit instruction blocks in-order, such as by changing the configuration state of the cores. Tearing down the plurality of block-based processor cores can also include enabling the cores to execute other instruction blocks.

At 760, the emitted object code can be stored in a computer-readable memory or storage device. For example, the emitted object code can be stored into a memory of the block-based processor so that the block-based processor can execute the program. As another example, the emitted object code can be loaded onto a storage device, such as a hard-disk drive of the block-based processor so that the block-based processor can execute the program.

### IX. Examples of a Block-Based Processor During Execution

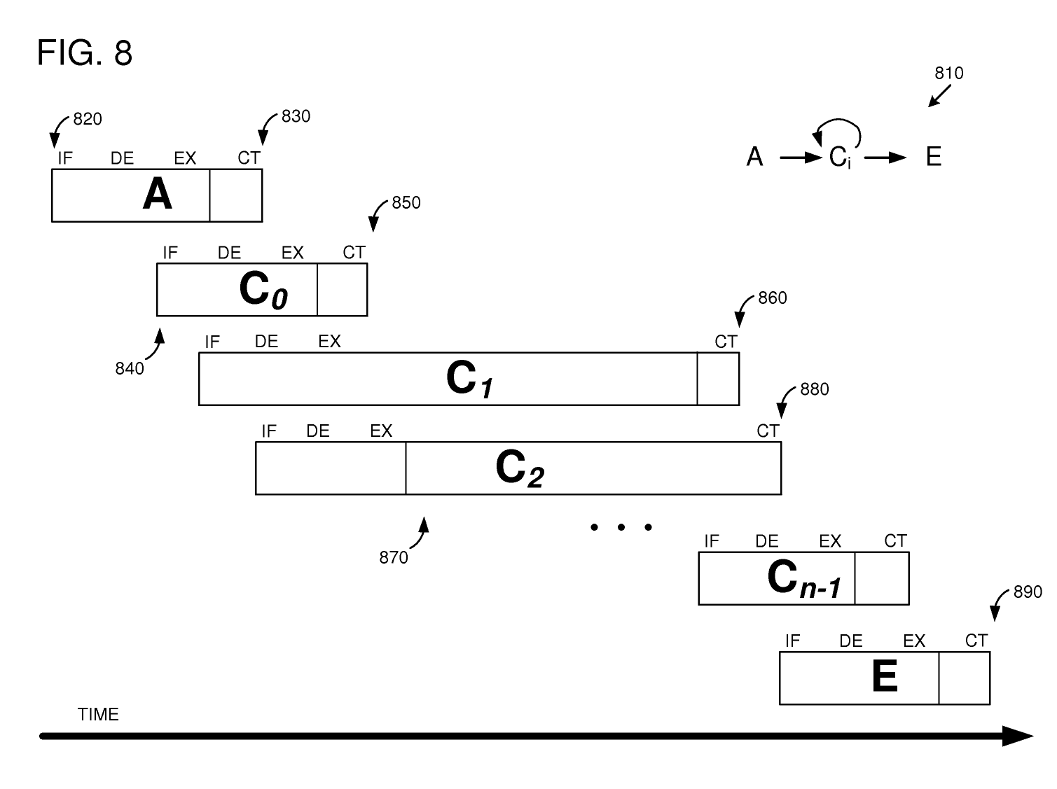

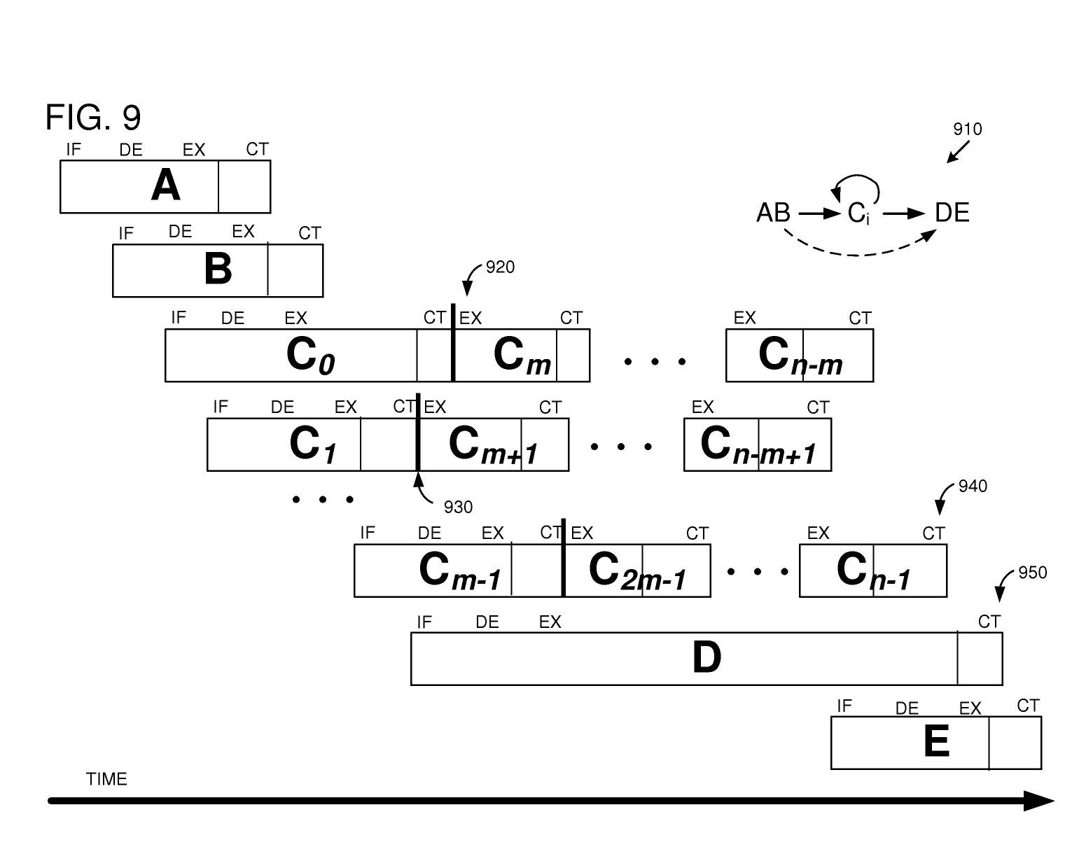

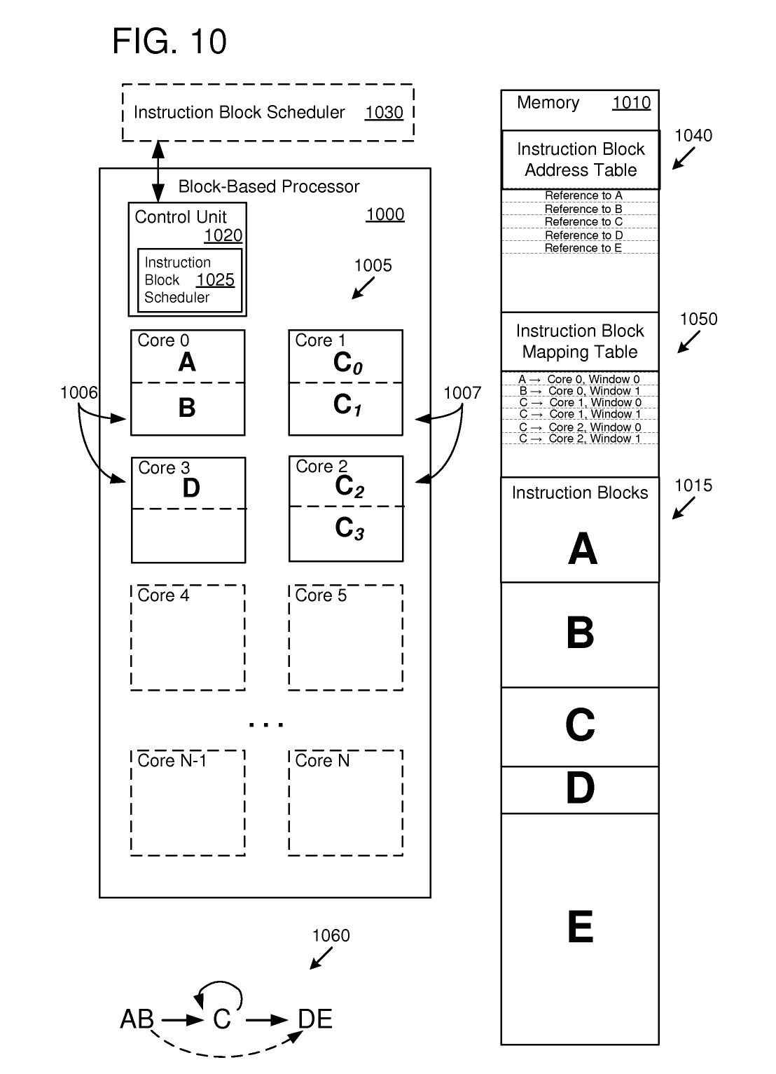

As described above, a program compiled for a block-based processor can include a sequence of instruction blocks. To run the program on the block-based processor, respective instruction blocks can be mapped to and executed on the individual processor cores based on architectural constraints, available hardware resources, and the dynamic flow of the program. When all of the instruction blocks are committed in program order (in-order), the program will be executed correctly, but the performance may be less than what is possible. By committing some of the instruction blocks out-of-order, the performance may be increased while still executing the program correctly. To illustrate the potential speed-up, FIG. 8 illustrates an example of committing instruction blocks in-order and FIG. 9 illustrates an example of committing instruction blocks out-of-order. FIG. 10 illustrates further aspects of committing instruction blocks out-of-order, such as an example of how the instruction blocks can be mapped to a block-based processor and memory.

FIG. 8 is a timing diagram illustrating an example of committing instruction blocks in-order. As a specific example, a short program can include the instruction blocks A, Cᵢ, and E. A program structure or dataflow diagram 810 of the program shows that the program begins with instruction block A which branches unconditionally to instruction block Cᵢ, which can either loop back to itself or branch to instruction block E. Instruction block Cᵢ is a loop body and it can be repeatedly executed n times, where n is an integer greater than zero. Different instances of the loop body can be mapped to different instruction windows and/or processor cores so that execution of the different instances can be overlapped to reduce the time to complete the program.

At time 820, instruction block A can be fetched (IF) by a first processor core. The processor core can decode (DE) and execute (EX) the individual instruction(s) of the instruction block A. It should be noted that when the processor cores are pipelined, the IF, DE, and EX phases for a particular instruction block may overlap (e.g., a first instruction can be in the IF phase, a second instruction can be in the DE phase, and a third instruction can be in the EX phase). When all of the instructions of instruction block A are complete, at time 830, the instruction block A can be committed (CT). At time 840, the initial iteration of instruction block Cᵢ (C₀) can be fetched. As shown, the fetching of block C₀ can occur in parallel with the decoding and executing of instruction block A, such as by mapping instruction block C₀ to an instruction window or processor core that is different than the instruction window or processor core used to execute instruction block A. It should be noted that for ease of illustration, the decode and execute stages are not shown for the instruction block C₀ and subsequent blocks. At time 850, the instruction block C₀ can be committed.

As illustrated, the next iteration of instruction block Cᵢ (C₁) takes much longer to complete than instruction block C₀. For example, instruction block C₁ may be delayed due to a resource conflict with another instruction block or due to longer access times to memory (such as because of a cache miss). Instruction block C₁ commits at time 860. When the blocks commit in-order, all blocks later in the order will get stalled behind instruction block C₁. Thus, even if instruction block C₂ is finished executing at time 870 and is ready to commit, the block C₂ cannot commit until after block C₁ commits. For example, the block C₂ can commit at time 880. The instruction block E cannot commit until after all iterations of the Cᵢ loop body are complete, such as at time 890.

FIG. 9 is a timing diagram illustrating an example of committing instruction blocks out-of-order. In this example, the short program including the instruction blocks A, Cᵢ, and E is compiled for a block-based processor that can commit instruction blocks out-of-order. Instruction blocks B and D can be added to support out-of-order execution. Specifically, instruction block B can include instructions for enabling different instances of the Cᵢ block to be committed out-of-order, and instruction block D can include instructions for synchronizing the cores executing the Cᵢ block and reconfiguring the cores to commit instruction blocks in-order. A dataflow diagram 910 of the program shows the relationship of the instruction blocks. In one embodiment, instruction block B can branch to an instance of the Cᵢ instruction block which can branch to instruction block D. In an alternative embodiment, instruction block B can initiate execution of the instances of the Cᵢ instruction blocks and then branch to instruction block D.

Instruction blocks A and B can commit in-order. Instruction block B can include instructions to enable the different instances of the Cᵢ block to be committed out-of-order and to initiate the execution of the Cᵢ instances. The Cᵢ loop bodies can be committed out-of-order, without affecting the correctness of the program, when the different iterations of the loop are independent of each other. As illustrated, the Cᵢ instances are executed in parallel on m different processor cores, where each processor core executes n/m iterations. For example, a first processor core can execute iterations 0, m, . . . n-m, and a second processor core can execute iterations 1, m+1, . . . n-m+1 of the loop body Cᵢ. During the initial iteration of the loop body on a particular processor core, the core will transition through the fetch, decode, execute, and commit phases. Using the refresh capability of the processor cores, subsequent iterations on the particular processor core can execute and commit the instruction block without re-fetching and re-decoding. Thus, the loop can be performed in less time using less energy by not performing the fetch and decode phases for the subsequent iterations. By committing the loop instances out-of-order, a stall of one instruction block may have less impact on subsequent iterations of the loop. For example, when instance C₀ is delayed and cannot commit until time 920, instance C₁ executing on a different processor core can commit before instance C₀ at time 930.

Instruction block D can be used to synchronize different processor cores executing the Cᵢ loop bodies. For example, the instruction block D can wait for all of the loop iterations to complete at time 940. Instruction block D can reconfigure the m processor cores that executed the Cᵢ loop bodies to commit instruction blocks in-order. Instruction block D can commit at time 950 which is subsequent to time 940.

FIG. 10 is a diagram illustrating an example of a block-based processor 1000 and memory 1010. The block-based processor 1000 can include a plurality of homogeneous or heterogeneous processor cores 1005 (e.g., Core 0-Core N) for executing instruction blocks 1015 (e.g., instruction blocks A-E) that are stored in memory 1010. The block-based processor 1000 can include a control unit 1020 having an instruction block scheduler 1025 for scheduling the instruction blocks 1015 on the processor cores 1005. In some embodiments, the control unit 1020 can be implemented at least in part using one or more of: hardwired finite state machines, programmable microcode, programmable gate arrays, or other suitable control circuits. In one embodiment, the control unit 1020 can be one of the processor cores 1005 running an instruction block that performs control functions of the block-based processor 1000, such as instruction block scheduling. In another embodiment, an external instruction block scheduler 1030 (e.g., an on-chip or off-chip processor executing scheduling code) can be used to schedule the instruction blocks on the processor cores 1005. The cores 1005 and the control unit 1020 can communicate with each other.

The memory 1010 is readable and writeable by the block-based processor 1000. The memory 1010 can include embedded memory on the block-based processor 1000, a level 1 (L1) cache, L2 cache, main memory, and secondary storage, for example. The memory 1010 can include one or more programs comprising the instruction blocks 1015 to be executed on the block-based processor 1000, program data (not shown), and data structures for managing the hardware resources of the block-based processor 1000. For example, the data structures stored in the memory 1010 can include an instruction block address table 1040 storing the starting locations to the instruction blocks, an instruction block mapping table 1050 storing the mappings of instruction blocks to processor cores, an idle pool (not shown) of processors that are available to run instruction blocks, a reusable pool (not shown) of idle processor cores having resident instruction blocks, and other data structures. The instruction block scheduler 1025 can reference and manipulate these data structures when determining which instruction blocks can be scheduled or allocated to which processor cores 1005.

The instruction block scheduler 1025 (or 1030) can allocate the processor cores 1005 so that one or more programs can be executed on the block-based processor 1000. For example, the instruction block scheduler 1025 can allocate instruction blocks of a program to one or more of the processor cores 1005 that are idle. The instruction blocks of the program can be allocated to the processor cores 1005 as the program is being executed, so only a portion of the instruction blocks of the program may be resident on the processor cores 1005 at any given time. As a specific example, a short program can include the instruction blocks A-E, having a dataflow diagram 1060. As shown in FIG. 10, the instruction block scheduler 1025 has allocated one processor core to execute the instruction blocks A-B, two processor cores to execute multiple iterations of the instruction block C, and one processor core to execute the instruction block D. In this example, multiple instruction blocks can be scheduled to a given processor core. For example, a processor core may have storage for up to 128 decoded instructions which can be further divided into instruction block slots or instruction windows with storage for up to 32 decoded instructions. Thus, a given processor core may execute from one to four instruction blocks sequentially or concurrently. It may be desirable to pack the instruction blocks into fewer processor cores so that more instruction blocks can be loaded and executing on the block-based processor 1000 at one time.

Specifically, processor core 0, instruction window 0 is allocated for block A and processor core 0, instruction window 1 is allocated for block B (blocks A and B are resident on core 0). Processor cores 1 and 2 are allocated for instruction block C, which is a loop body. Specifically, processor core 1, instruction window 0 is allocated for a first instance of block C (C₀), processor core 1, instruction window 1 is allocated for a second instance of block C (C₁), processor core 2, instruction window 0 is allocated for a third instance of block C (C₂), and processor core 2, instruction window 1 is allocated for a fourth instance of block C (C₃). Each of the instances of the loop body C can be used to execute one or more iterations of the loop body C. For example, if the loop has 1,000 iterations, C₀ can be used to perform 250 iterations, C₁ can be used to perform 250 iterations, C₂ can be used to perform 250 iterations, and C₃ can be used to perform 250 iterations. Each of the instances of the loop body C can be refreshed for each iteration after the initial iteration so that the loop body C is repeatedly executed and committed without re-fetching and re-decoding the loop body C. Thus, when executing the loop body 250 times on a given instruction window, the time and energy associated with fetching and decoding the loop body can be saved for 249 iterations, for example.

Instruction block B can include initialization code for enabling the loop iterations of block C to commit out-of-order. For example, the instructions of block B can include instructions to load and/or reserve physical memory for the loop. As specific examples, the instructions can read memory locations associated with the input set of the loop and/or allocate memory for the output set of the loop so that all memory locations used by the block C are resident in physical memory (e.g., so that the input set and the output set of block C are not paged out). The locations associated with the loop can be locked in physical memory by programming one or more page table entries stored in memory and/or programming registers of the MMU (such as by writing to CSRs of the MMU) so that the memory will not be swapped out, for example.

The instructions of block B can include instructions to pin one or more iterations of the loop body C to one or more processor cores and/or instruction windows. Pinning an instruction block to a core includes allocating a core to execute the instruction block and keeping the instruction block resident on the core until a tear-down condition is met. Pinning the instruction block to the core can include programming the core through its CSRs and/or communicating and coordinating with the instruction block scheduler 1025. As a specific example, the instruction block scheduler 1025 can be queried to determine which cores are available (e.g., idle) and/or which cores can be allocated (e.g., which cores are associated with the executing thread). Based on the results of the query, a group of cores can be selected to execute the loop bodies. The selected group of cores can be placed on a reserved list so that the block scheduler 1025 does not reallocate the cores. The selected cores can be configured by writing to their CSRs. Configuration can include enabling the selected cores to commit instructions out-of-order, defining a number of times to repeatedly execute the instruction block on a respective core, and/or enabling the cores to halt when the loop iterations are complete. As illustrated, core 0 executing block B can configure the cores 1 and 2 to repeatedly execute the different instances of the loop body C, and to commit the instances out-of-order.

The program can include portions that are to be committed in-order and portions that are to be committed out-of-order. For example, the program segments A-B and D-E can be committed in-order (e.g., on cores 0 and 3 (1006)) and the iterations of the loop bodies C can be committed out-of-order (e.g., on cores 1 and 2 (1007)). The out-of-order portions can be synchronized to the in-order portions in various ways. As one example, instruction block B can initiate execution of the loop bodies C and branch to instruction block D which is programmed as a synchronization point or bather. As another example, instruction block B can initiate execution of the loop bodies C, branch to one of the instances of the loop bodies C, which can branch to instruction block D which is programmed as a synchronization point. Instruction block D can be allocated to an idle instruction window, such as to core 0, instruction window 0 (when block A has been committed) or to core 3 (as shown in FIG. 10). The multiple cores executing the loop bodies C out-of-order can execute and commit until they reach a tear-down condition, such as when a maximum number of iterations are committed, for example. Each of the cores executing the loop bodies C can halt execution at the tear-down condition until the cores are reconfigured to fetch a new instruction block.

Instruction block D can include instructions for creating a synchronization point. As one example, the synchronization code can determine the processing state associated with each of the processor cores executing the loop bodies C. Specifically, CSRs corresponding to the processing state of each of the processor cores can be polled until the state for all of the processor cores is idle. As another example, each of the processor cores executing the loop body C can send a signal or message to the processor core executing the synchronizing code. When signals or messages are received from all of the processor cores, the synchronization code can continue. As another example, each of the processor cores executing the loop bodies C can write a particular value to a memory location reserved for the core when the core has completed executing all iterations of the loop body C. The synchronizing block D can determine that all of the cores are complete, when all of the memory locations corresponding to the cores contain the particular value. In sum, when all of the processor cores executing out-of-order are complete, the tear-down condition can be satisfied and the processor cores that executed the loop bodies C out-of-order can be torn down.

Instruction block D can include instructions for tearing down the processor cores executing the loop bodies C. Tearing down the processor cores can include reconfiguring the cores to commit instruction blocks in-order, such as by writing to the CSRs of the processor cores to change the configuration state of the cores. Tearing down the plurality of block-based processor cores can also include enabling the cores to execute other instruction blocks. For example the cores can be removed from the reserved list of the instruction block scheduler 1025. In other words, the loop bodies C can be un-pinned from the processor cores so that different instruction blocks can be executed on the processor cores.

### X. Example Methods of Reusing Decoded Instructions

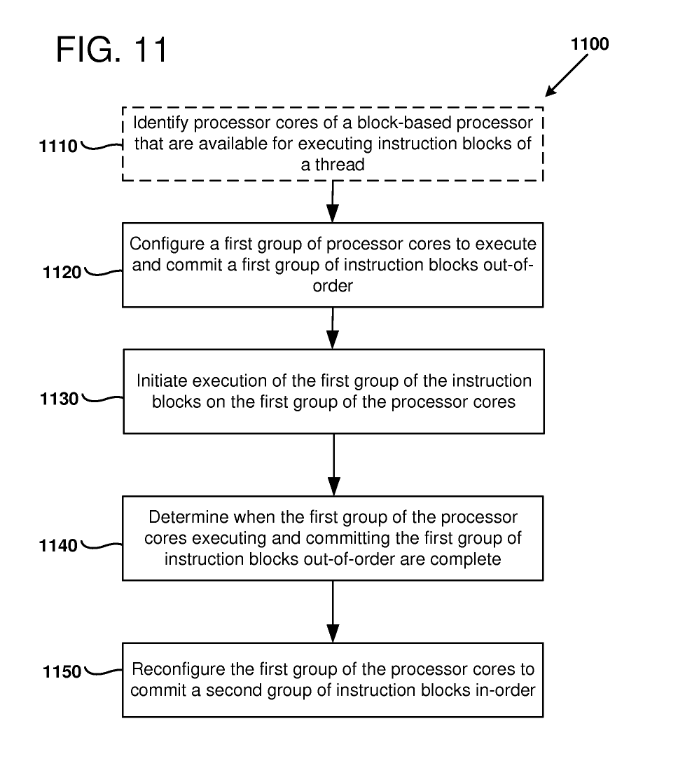

FIG. 11 is a flowchart illustrating an example of a method 1100 of executing and committing instruction blocks out-of-order in a block-based processor. For example, the instruction blocks can be within an execution thread of a program being executed on the block-based processor. A program can include one or more threads that can be managed by an operating system. Each thread can execute independently of the other threads until a shared synchronization point of the threads is encountered. As described herein, instruction blocks within a single thread can potentially achieve multi-threaded performance, such as by enabling the instruction blocks of the thread to execute out-of-order. This performance increase can occur without operating system intervention and without complicated out-of-order hardware mechanisms used by superscalar processors.

At 1110, a group of processor cores that are available for executing instruction blocks of a given thread can optionally be identified. As one example, each processor core can include programmable state for storing a thread identifier, and the thread identifiers associated with each of the processor cores can be compared to a thread identifier for the given thread. As another example, a control unit of the block-based processor can store identifiers for each core that is associated with the given thread in a data structure stored in memory of the block-based processor. The available processor cores can be identified by reading the information from the data structure stored in the memory.

At 1120, a first group of processor cores can be configured to execute and commit a first group of instruction blocks out-of-order. For example, the first group of processor cores can be selected from the group of the processor cores identified at 1110. As another example, the first group of processor cores can be predefined by a compiler or a programmer. As yet another example, the first group of processor cores can be dynamically allocated by an initialization code block. Specifically, there can be a pool or cache of idle processor cores that are reserved until requested by an allocation command, and the first group of processor cores can be allocated from this pool.

The first group of instruction blocks can include different instances of a given loop body so that different iterations of the loop can be executed on different processors in parallel. The loop body can perform a single iteration of the loop, or the loop can be unrolled so that each loop body can perform multiple iterations of the loop. As another example, the first group of instruction blocks can include groups of instruction blocks that are independent of each other, but are not part of a loop.

The first group of processor cores can be configured, at least in part, by executing an instruction block that is not part of the first group of instruction blocks. For example, the instruction block can include configuration code and the core executing the configuration code can communicate with the first group of processor cores via signals and/or messages sent to the first group of processor cores. Configuration of the cores can include setting configuration state so that the block can commit instruction blocks out-of-order. Configuration of the cores to can include loading a counter with a number proportional to a number of times to refresh or repeatedly execute the instruction blocks.

The first group of processor cores can be configured, at least in part, by decoding a header of an instruction block of the first group of instruction blocks. For example, the header can include flags and other information about the instruction blocks to be executed out-of-order. As specific examples, the instruction block header can include: a flag to indicate that the instruction block can be committed out-of-order; a number of iterations to execute and commit the instruction block; and/or a flag that indicates the block is to be synchronized upon completion of executing the instruction block.

Other processor cores, not in the first group of processor cores, can also be configured as part of preparing for the first group of processor cores to execute and commit instruction blocks out-of-order. For example, interrupts can be masked for all of the processor cores in the given thread. As another example, a synchronization instruction block can be configured to monitor and wait for the first group of processor cores to finish committing the instruction blocks out-of-order.

At 1130, execution of the first group of the instruction blocks on the first group of the processor cores can be initiated. For example, a processor core executing configuration and/or initialization code can initiate the execution by sending a signal or message to each of the first group of the processor cores to start the execution. Specifically, the core can initiate the execution of each respective core after the respective core is configured at 1120, or execution can be initiated after a synchronization block is configured. As another example, the first group of the instruction blocks can be initiated by providing the first group of the processor cores with address(es) of one or more of the first group of the instruction blocks so that the core executing the blocks can initiate execution by fetching the instruction block from memory.

Once initiated, the first group of the instruction blocks can execute and commit out-of-order until a termination condition is met, such as when a programmed number of iterations are completed. For example, configuring the core can include loading a repeat counter with a desired number of iterations to execute, and the repeat counter can be decremented each time that the block is committed. For each repetition, the instruction block can be refreshed so that the block is not re-fetched and re-decoded. Refreshing the block can include resetting the active-ready state while not resetting the decoded-ready state. By refreshing the block, the time and energy that would be used to re-fetch and re-decode the block can be saved as compared to loading the instruction block onto a different core. The core can halt operation and/or send a signal indicating that the core has completed all iterations of the block.

At 1140, it can be determined whether the first group of the processor cores executing and committing the first group of instruction blocks out-of-order are complete. For example, an instruction block including synchronization code can be executed. The synchronization block can execute when the initialization block and/or one or more of the first group of the instruction blocks branch to the synchronization block. The synchronization block can be configured to commit in-order and to wait for all of the first group of instruction blocks to complete all of their iterations. Thus, the program thread cannot proceed past the synchronization block until after the first group of instruction blocks are complete. For example, the synchronization block can receive messages and/or signals from the cores when the cores executing blocks out-of-order are complete. Additionally or alternatively, the synchronization block can read a state of the cores executing blocks out-of-order to determine if the respective cores are complete. The synchronization block can compare the cores that have finished to the cores that are executing to determine if all of the cores are complete. Once all of the cores are complete, the first group of the processor cores can be torn down. For example, tearing down the first group of the processor cores can include reconfiguring the first group of the processor cores to commit instruction block in-order. Synchronization can be complete and the program thread can be released to continue with in-order execution after the first group of the processor cores have been torn down.

At 1150, the first group of the processor cores can be reconfigured to commit a second group of instruction blocks in-order. For example, the second group of instruction blocks can be the group of instructions that are after a loop that has independent iterations. Reconfiguring the first group of the processor cores can include executing instructions of a synchronization and/or tear-down instruction block to change configuration state of the first group of the processor cores. For example, the core executing the synchronization and/or tear-down code can send signals or messages to the first group of the processor cores to perform the reconfiguration. As another example, the first group of the processor cores can be automatically reconfigured when the cores are finished executing the blocks out-of-order. In particular, the respective cores of the first group of the processor cores can be reconfigured to execute instruction blocks in-order when the repeat counter reaches zero.

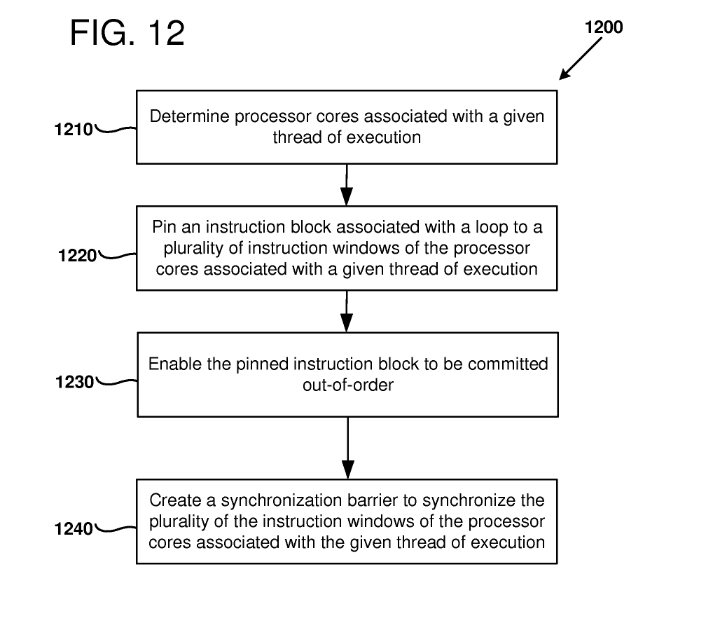

FIG. 12 is a flowchart illustrating an example method 1200 of executing and committing instruction blocks out-of-order in a block-based processor. At 1210, processor cores associated with a given thread of execution can be determined. In one embodiment, the block-based processor may be single threaded with a single program counter. Thus, all processor cores of the block-based processor can be associated with the given thread of execution. In an alternative embodiment, the block-based processor can support the execution of multiple threads, where each thread has a thread identifier and a program counter associated with the thread. Different cores can be assigned to the different threads. The cores can be assigned to a thread at the beginning of execution of the program or dynamically as the program is executed. As described above, the mapping of cores to threads can include recording the mappings in a data structure in a memory accessible by the block-based processor and/or writing the thread identifier to a register of the individual cores. The cores associated with the given thread can be determined by finding one or more of the cores that share the same thread identifier as the executing thread.

At 1220, an instruction block associated with a loop can be pinned to a plurality of instruction windows of the processor cores associated with the given thread of execution. Generally, instruction blocks can be mapped to processor cores and/or instruction windows of the block-based processor. Multiple blocks can be mapped to a single core based on the size of the blocks, the capabilities of the cores (e.g., the number of instruction windows), the configuration of the cores, and alignment considerations. Different instances of the same instruction block can be mapped to different processor cores and/or different instruction windows of the same processor core. Pinning the instruction block to the instruction window can include mapping or allocating the block to the instruction window and preventing the block from being evicted until the block is explicitly removed (e.g., torn-down and/or remapped) from the instruction window, such as by an instruction of a synchronization block. Pinning the instruction block to the instruction window can include configuring one or more aspects of the instruction window, such as specifying a number of times to repeatedly execute the instruction block on the instruction window.

At 1230, the pinned instruction block can be enabled to commit out-of-order. For example, the pinned instruction block can be enabled to commit out-of-order by instructions of initialization code executing on a different processor core. As another example, an instruction header of the pinned instruction block can include a flag to commit the block out-of-order, and the block can be enabled to commit out-of-order by logic decoding the instruction header.

When executed, the pinned instruction block can commit out-of-order relative to program order. Thus, the different instruction windows of the plurality of instruction windows can commit the different iterations of the loop independent of each other. As a comparison, a loop iterating 1,000 times and committing in-order would commit iterations in the order of 0, 1, 2, . . . 999. A stall of iteration 2 may cause delay in committing all subsequent iterations (e.g., 3 and greater). In contrast, a loop iterating 1,000 times and committing out-of-order may commit iterations in the order of 1, 0, 3, 5, 2, . . . 999, 997, 998, for example. A stall of iteration 2 may cause a delay in committing all subsequent iterations executing on the same instruction window as iteration 2, but the iterations executing on different instruction windows may be unaffected by the stall of iteration 2. Thus, the loop can potentially execute faster when committing out-of-order as compared to when the loop is committed in-order.

At 1240, a synchronization barrier can be created to synchronize the plurality of the instruction windows of the processor cores associated with the given thread of execution. In general, a synchronization barrier can be created when the flow of program execution is parallelized for a portion of the program between two sequential portions of the program. In particular, the synchronization barrier can be used to join the parallel flows back at a common point (e.g., instruction block) of the program. Thus, the program cannot execute past the synchronization barrier until all of the parallel execution flows are complete and the synchronization barrier releases the program to continue execution past the synchronization barrier. The synchronization barrier can include code to determine a state associated with each of the instruction windows of the plurality of the instruction windows. For example, the synchronization barrier can determine if all of the instruction windows are finished executing and committing the pinned instruction block out-of-order. The state of an instruction window can be determined by reading configuration state from the core corresponding to the instruction window, by receiving a signal or message from the instruction window, and/or by reading a memory location that is shared by the instruction window and the synchronization barrier, for example. The synchronization barrier can release the program to continue execution past the synchronization barrier by executing a branch instruction to another instruction block, for example.

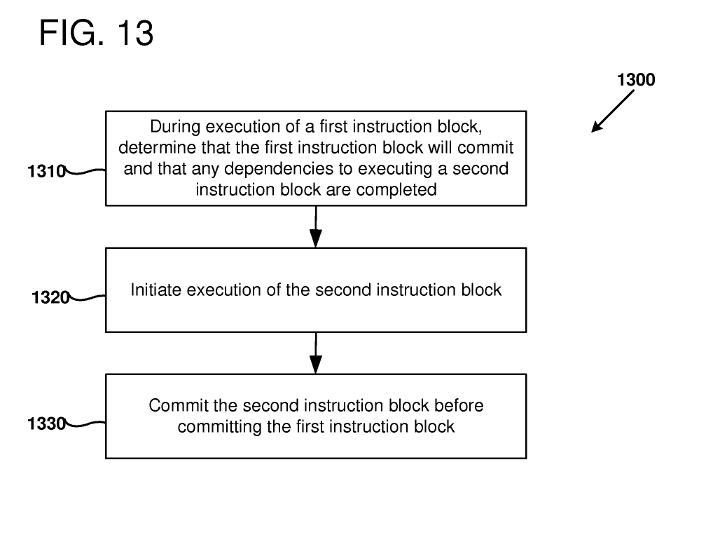

FIG. 13 is a flowchart illustrating an example method 1300 of executing and committing instruction blocks out-of-order in a block-based processor. At 1310, during execution of a first instruction block, it can be determined that the first instruction block will commit and that any dependencies to executing a second instruction block are completed. For example, the dependencies to execute the second instruction block can be encoded in an instruction header of the first instruction block by the compiler. The core executing the first instruction block can monitor that status of the dependencies to execute the second instruction block, and when the dependencies are completed, at 1320, the execution of the second instruction block can be initiated. The second instruction block can execute in a different instruction window of the same core that is executing the first instruction block, or the second instruction block can execute on a different core. The second instruction block can complete execution, and at 1330, the second block can commit before the first instruction block. Thus, the second block can execute non-speculatively and commit out-of-order (e.g., before the first instruction block).

### XI. Example Computing Environment

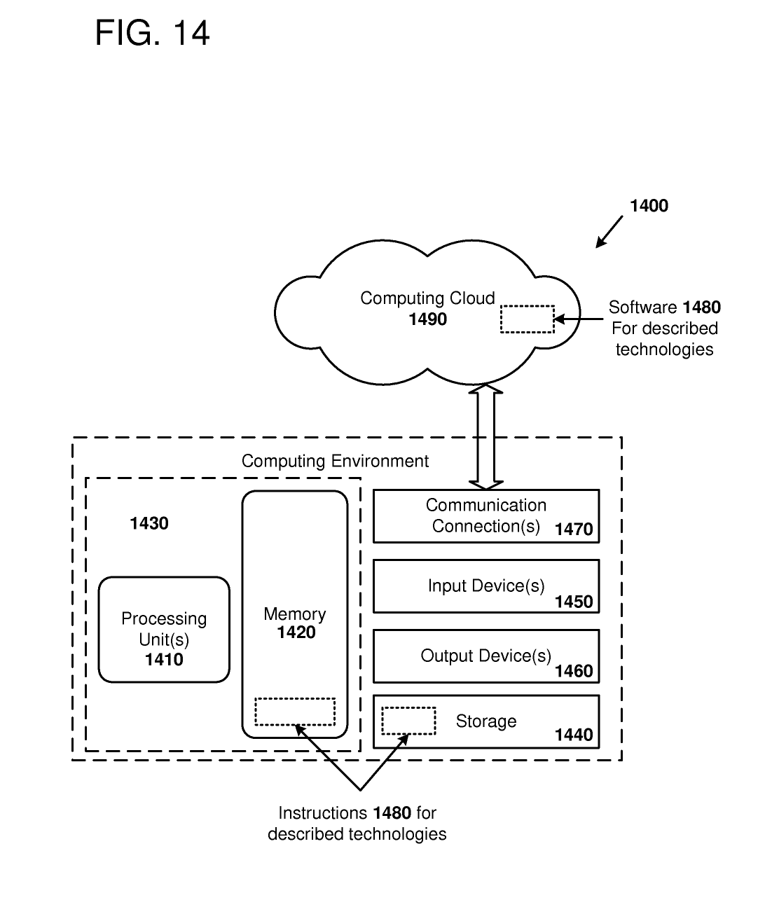

FIG. 14 illustrates a generalized example of a suitable computing environment 1400 in which described embodiments, techniques, and technologies, including bad jump detection in a block-based processor, can be implemented. For example, the computing environment 1400 can implement disclosed techniques for verifying branch instruction target locations, as described herein.

The computing environment 1400 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 14, the computing environment 1400 includes at least one block-based processing unit 1410 and memory 1420. In FIG. 14, this most basic configuration 1430 is included within a dashed line. The block-based processing unit 1410 executes computer-executable instructions and may be a real or a virtual processor. In a multi-processing system, multiple processing units execute computer-executable instructions to increase processing power and as such, multiple processors can be running simultaneously. The memory 1420 may be volatile memory (e.g., registers, cache, RAM), non-volatile memory (e.g., ROM, EEPROM, flash memory, etc.), or some combination of the two. The memory 1420 stores software 1480, images, and video that can, for example, implement the technologies described herein. A computing environment may have additional features. For example, the computing environment 1400 includes storage 1440, one or more input devices 1450, one or more output devices 1460, and one or more communication connections 1470. An interconnection mechanism (not shown) such as a bus, a controller, or a network, interconnects the components of the computing environment 1400. Typically, operating system software (not shown) provides an operating environment for other software executing in the computing environment 1400, and coordinates activities of the components of the computing environment 1400.

The storage 1440 may be removable or non-removable, and includes magnetic disks, magnetic tapes or cassettes, CD-ROMs, CD-RWs, DVDs, or any other medium which can be used to store information and that can be accessed within the computing environment 1400. The storage 1440 stores instructions for the software 1480, plugin data, and messages, which can be used to implement technologies described herein.

The input device(s) 1450 may be a touch input device, such as a keyboard, keypad, mouse, touch screen display, pen, or trackball, a voice input device, a scanning device, or another device, that provides input to the computing environment 1400. For audio, the input device(s) 1450 may be a sound card or similar device that accepts audio input in analog or digital form, or a CD-ROM reader that provides audio samples to the computing environment 1400. The output device(s) 1460 may be a display, printer, speaker, CD-writer, or another device that provides output from the computing environment 1400.

The communication connection(s) 1470 enable communication over a communication medium (e.g., a connecting network) to another computing entity. The communication medium conveys information such as computer-executable instructions, compressed graphics information, video, or other data in a modulated data signal. The communication connection(s) 1470 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1490. For example, disclosed compilers and/or block-based-processor servers are located in the computing environment, or the disclosed compilers can be executed on servers located in the computing cloud 1490. In some examples, the disclosed compilers execute on traditional central processing units (e.g., RISC or CISC processors).

Computer-readable media are any available media that can be accessed within a computing environment 1400. By way of example, and not limitation, with the computing environment 1400, computer-readable media include memory 1420 and/or storage 1440. As should be readily understood, the term computer-readable storage media includes the media for data storage such as memory 1420 and storage 1440, and not transmission media such as modulated data signals.

### X. Additional Examples of the Disclosed Technology

Additional examples of the disclosed subject matter are discussed herein in accordance with the examples discussed above.

In one embodiment, an apparatus can be used for executing and committing a set of instruction blocks having a sequential program order. The apparatus can include a plurality of block-based processor cores which can include a first group of two or more cores and a second group of one or more cores. The first group of cores can be configured to commit instruction blocks of the set of instruction blocks in sequential program order. The second group of cores can be configured to commit instruction blocks of the set of instruction blocks out-of-order relative to the sequential program order.

A respective core of the plurality of block-based processor cores can be configurable to commit a given instruction block in-order relative to the sequential program order or to commit the given instruction block out-of-order relative to the sequential program order. A respective core of the plurality of block-based processor cores can be configurable to commit a given instruction block out-of-order based in part on information in a header of the instruction block. A respective core of the plurality of block-based processor cores can be configurable to commit the instruction block out-of-order based in part by executing a different instruction block on a different core of the plurality of block-based processor cores. A respective core of the plurality of block-based processor cores can be configured to execute a resident instruction block in a refresh mode where execution and commit of the resident instruction block is repeated without re-fetching and re-decoding the resident instruction block. A respective core of the plurality of block-based processor cores can include a counter to indicate a number of times to repeat execution the resident instruction block. A respective core of the plurality of block-based processor cores can commit the resident instruction block out-of-order when the counter is non-zero and the respective core is reconfigured to commit instruction blocks in-order in response to the counter transitioning to zero. A respective core of the plurality of block-based processor cores can provide a notification to the other cores of the block-based processor cores when the counter is zero and the respective core is idle.

In one embodiment, a method of executing instruction blocks in a block-based processor can include configuring a first group of one or more processor cores of the block-based processor to execute and commit a first group of one or more instruction blocks out-of-order. The method can include initiating the execution of first group of the instruction blocks on the first group of the processor cores. The method can include determining when the first group of the processor cores executing and committing the first group of instruction blocks out-of-order are complete. The method can include reconfiguring the first group of the processor cores to commit a second group of instruction blocks in-order.

The first group of instruction blocks executing and committing on the first group of the processor cores can include different instances of a given loop body. A first instance of the different instances of the given loop body can be associated with a first instruction window of a particular processor core of the first group of processor cores and a second instance of the different instances of the given loop body can be associated with a second instruction window of the particular processor core. Each of the different instances of the given loop body can be unrolled. Configuring the first group of the processor cores to execute and commit instruction blocks out-of-order can include identifying a second group of processor cores that are available for executing instruction blocks of a given thread, and the first group of the processor cores can be selected from the second group of the processor cores. The method can optionally include masking interrupts for the second group of the processor cores when the first group of the processor cores are executing and committing instruction blocks out-of-order. Configuring the first group of processor cores to execute and commit the first group of instruction blocks out-of-order can include loading a counter with a number proportional to a number of times to refresh the instruction blocks.

In one embodiment, one or more computer-readable storage media store computer-executable instructions for a block-based processor comprising multiple processor cores. The instructions can include instructions to cause the block-based processor to determine processor cores associated with a given thread of execution. The instructions can include instructions to cause the block-based processor to pin an instruction block associated with a loop to a plurality of instruction windows of the processor cores associated with the given thread of execution. The instructions can include instructions to cause the block-based processor to enable the pinned instruction block to be committed out-of-order. The instructions can include instructions to cause the block-based processor to create a synchronization barrier to synchronize the plurality of the instruction windows of the processor cores associated with the given thread of execution. The synchronization barrier can include instructions to cause the block-based processor to determine a state associated with each of the instruction windows of the plurality of the instruction windows. Pinning the instruction block associated with the loop to the plurality of instruction windows can include specifying a number of times to repeatedly execute the instruction block on respective instruction windows. The computer-readable instructions stored on the one or more computer-readable storage media can be generated by a method. The method can include receiving source code and/or object code; and transforming the source code and/or object code into the computer-readable instructions.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. An apparatus for executing and committing a set of instruction blocks having a sequential program order, the apparatus comprising:
a plurality of block-based processor cores comprising:
a first group of two or more cores being configured to commit instruction blocks of the set of instruction blocks in a sequential program order; and
a second group of one or more cores being configured to commit instruction blocks of the set of instruction blocks out-of-order relative to the sequential program order.

2. The apparatus of claim 1, wherein a respective core of the plurality of block-based processor cores is configurable to commit a given instruction block in-order relative to the sequential program order or to commit the given instruction block out-of-order relative to the sequential program order.

3. The apparatus of claim 1, wherein a respective core of the plurality of block-based processor cores is configurable to commit a given instruction block out-of-order based in part on information in a header of the instruction block.

4. The apparatus of claim 1, wherein a respective core of the plurality of block-based processor cores is configurable to commit the instruction block out-of-order based in part by executing a different instruction block on a different core of the plurality of block-based processor cores.

5. The apparatus of claim 1, wherein a respective core of the plurality of block-based processor cores is configured to execute a resident instruction block in a refresh mode where execution and commit of the resident instruction block is repeated without re-fetching and re-decoding the resident instruction block.

6. The apparatus of claim 5, wherein a respective core of the plurality of block-based processor cores comprises a counter to indicate a number of times to repeat execution the resident instruction block.

7. The apparatus of claim 6, wherein a respective core of the plurality of block-based processor cores commits the resident instruction block out-of-order when the counter is non-zero and the respective core is reconfigured to commit instruction blocks in-order in response to the counter transitioning to zero.

8. The apparatus of claim 6, wherein a respective core of the plurality of block-based processor cores provides a notification to the other cores of the block-based processor cores when the counter is zero and the respective core is idle.

9. A method of executing instruction blocks in a block-based processor, the method comprising:
configuring a first group of one or more processor cores of the block-based processor to execute and commit a first group of one or more instruction blocks out-of-order;
initiating the execution of first group of the instruction blocks on the first group of the processor cores;
determining the first group of the processor cores executing and committing the first group of instruction blocks out-of-order are complete; and
responsive to the determining, reconfiguring the first group of the processor cores to commit a second group of instruction blocks in-order.

10. The method of claim 9, wherein the first group of instruction blocks executing and committing on the first group of the processor cores comprise different instances of a given loop body.

11. The method of claim 10, wherein a first instance of the different instances of the given loop body is associated with a first instruction window of a particular processor core of the first group of processor cores and a second instance of the different instances of the given loop body is associated with a second instruction window of the particular processor core.

12. The method of claim 10, wherein each of the different instances of the given loop body are unrolled.

13. The method of claim 9, wherein configuring the first group of the processor cores to execute and commit instruction blocks out-of-order comprises identifying a second group of processor cores that are available for executing instruction blocks of a given thread, and the first group of the processor cores is selected from the second group of the processor cores.

14. The method of claim 13, further comprising:
masking interrupts for the second group of the processor cores when the first group of the processor cores are executing and committing instruction blocks out-of-order.

15. The method of claim 9, wherein the configuring the first group of processor cores to execute and commit the first group of instruction blocks out-of-order comprises loading a counter with a number proportional to a number of times to refresh the instruction blocks.

16. One or more computer-readable storage media storing computer-readable instructions for a block-based computer system, that when executed cause the system to perform the method of claim 9.

17. One or more computer-readable storage media storing computer-readable instructions for a block-based processor comprising multiple processor cores, that when executed cause the processor to perform a method, the instructions comprising:
instructions to cause the block-based processor to determine processor cores associated with a given thread of execution;
instructions to cause the block-based processor to pin an instruction block associated with a loop to a plurality of instruction windows of the processor cores associated with the given thread of execution;
instructions to cause the block-based processor to enable the pinned instruction block to be committed out-of-order; and
instructions to cause the block-based processor to create a synchronization barrier to synchronize the plurality of the instruction windows of the processor cores associated with the given thread of execution.

18. The computer-readable storage media of claim 17, wherein pinning the instruction block associated with the loop to the plurality of instruction windows comprises specifying a number of times to repeatedly execute the instruction block on respective instruction windows.

19. The computer-readable storage media of claim 17, wherein the synchronization barrier comprises instructions to cause the block-based processor to determine a state associated with each of the instruction windows of the plurality of the instruction windows.

20. The computer-readable storage media of claim 17, wherein the computer-readable instructions are generated by a method, the method comprising:
receiving source code and/or object code comprising the loop;
tuning the loop for execution on the block-based processor; and
transforming the source code and/or object code into the computer-readable instructions.
